(19) United States
(12) Patent Application Publication
(10) Pub. No.: US 2025/0048461 A1
(43) Pub. Date: Feb. 6, 2025

(54) RELAY NODE ASSOCIATION IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/781,921

(22) Filed: Jul. 23, 2024

Related U.S. Application Data
(60) Provisional application No. 63/529,954, filed on Jul. 31, 2023.

(51) Int. Cl. H04W 76/14; H04W 84/12; H04W 88/04

(52) U.S. Cl. CPC H04W 76/14; H04W 84/12; H04W 88/04

(57) ABSTRACT

A first station (STA) device in a wireless network, the first STA device comprising a memory and a processor coupled to the memory, the processor configured to transmit a first frame to a relay node that requests the relay node to perform a relay operation for a communication between the first STA and a second STA, receive a second frame from the relay node accepting the request to perform the relay operation for the communication between the first STA and the second STA, associate with the relay node based on the acceptance of the relay node to perform the relay operation, establish a relay link between the first STA and the relay node based on the association with the relay node, and communicate indirectly with the second STA via the relay link.

### CROSS-REFERENCE TO RELATED APPLICATIONS

This application claims the benefit of priority from U.S. Provisional Application No. 63/529,954, entitled “Method and Apparatus For Association in WLAN Systems” filed Jul. 31, 2023, which is incorporated herein by reference in its entirety.

### TECHNICAL FIELD

This disclosure relates generally to a wireless communication system, and more particularly to, for example, but not limited to, using relay nodes for communications between nodes in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA includes a memory and a processor coupled to the memory. The processor is configured to transmit a first frame to a relay node that requests the relay node to perform a relay operation for a communication between the first STA and a second STA. The processor is configured to receive a second frame from the relay node accepting the request to perform the relay operation for the communication between the first STA and the second STA. The processor is configured to associate with the relay node based on the acceptance of the relay node to perform the relay operation. The processor is configured to establish a relay link between the first STA and the relay node based on the association with the relay node. The processor is configured to communicate indirectly with the second STA via the relay link.

In some embodiments, the relay node is associated with the first STA and the second STA.

In some embodiments, the relay node has access point (AP) functionalities.

In some embodiments, the processor is further configured to receive a third frame from the relay node that includes information on an availability of the relay node including a time period during which the relay node is available to perform the relay operation.

In some embodiments, the processor is further configured to receive a third frame from the relay node that includes information regarding capabilities of the relay node to perform the relay operation.

In some embodiments, the processor is further configured to transmit a third frame to the relay node to temporarily disable the relay link with the relay node.

In some embodiments, the processor is further configured to transmit a fourth frame to the relay node to reassociate with the relay node and re-enable the relay link.

In some embodiments, the processor is further configured to transmit a third frame to the relay node that requests information regarding capabilities of the relay node to perform relay operations, and receive a fourth frame from the relay node that includes relay information including capabilities of the relay node to perform relay operations.

One aspect of the present disclosure provides a relay station (STA) in a wireless network. The relay STA comprises a memory and a processor coupled to the memory. The processor is configured to receive a first frame from a first STA that requests the relay STA to perform a relay operation for a communication between the first STA and a second STA. The processor is configured to transmit a second frame to the first STA accepting the request to perform the relay operation for the communication between the first STA and the second STA. The processor is configured to associate with the first STA based on the acceptance with the first STA to perform the relay operation. The processor is configured to establish a relay link between the relay STA and the first STA based on the association with the first STA. The processor is configured to transmit communications indirectly between the first STA and the second STA via the relay link with the first STA.

In some embodiments, the relay STA is associated with the first STA and the second STA.

In some embodiments, the relay STA has access point (AP) functionalities.

In some embodiments, the processor is further configured to transmit a third frame to the first STA that includes information on an availability of the relay STA including a time period during which the relay STA is available to perform the relay operation.

In some embodiments, the processor is further configured to transmit a third frame to the first STA that includes information regarding capabilities of the STA node to perform the relay operation.

In some embodiments, the processor is further configured to receive a third frame from the first STA to temporarily disable the relay link with the first STA.

In some embodiments, the processor is further configured to receive a fourth frame to the first STA to reassociate with the first STA and re-enable the relay link.

In some embodiments, the processor is further configured to receive a third frame from the first STA that requests information regarding capabilities of the relay STA to perform the relay operation, and transmit a fourth frame to the first STA that includes relay information including capabilities of the relay STA to perform relay operations.

One aspect of the present disclosure provides a computer-implemented method for facilitating communication at a first station (STA) in a wireless network. The method comprises transmitting a first frame to a relay node that requests the relay node to perform a relay operation for a communication between the first STA and a second STA. The method comprises receiving a second frame from the relay node accepting the request to perform the relay operation for the communication between the first STA and the second STA. The method comprises associating with the relay node based on the acceptance of the relay node to perform the relay operation. The method comprises establishing a relay link between the first STA and the relay node based on the association with the relay node. The method comprises communicating indirectly with the second STA via the relay link.

In some embodiments, the relay node is associated with the first STA and the second STA.

In some embodiments, the relay node has access point (AP) functionalities.

In some embodiments, the method further comprises receiving a third frame from the relay node that includes information on an availability of the relay node including a time period during which the relay node is available to perform the relay operation.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a typical network infrastructure in a WLAN system in accordance with an embodiment.

FIG. 5 illustrates a network infrastructure in a WLAN system with STAs that suffer from a low signal strength connection with an AP in accordance with an embodiment.

FIG. 6 illustrates association of a relay node with a source node in accordance with an embodiment.

FIG. 7 illustrates association of a relay node with a destination node in accordance with an embodiment.

FIG. 8 illustrates association of a relay node with both a source node and a destination node in accordance with an embodiment.

FIG. 9 illustrates an example flowchart of a process for associating by a first node with a relay node in accordance with an embodiment.

FIG. 10 illustrates an example flowchart of a process for associating by a relay node with a first node in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

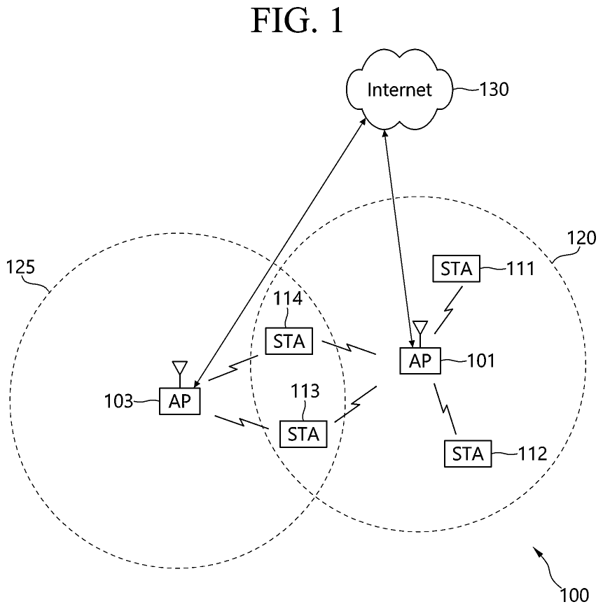

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

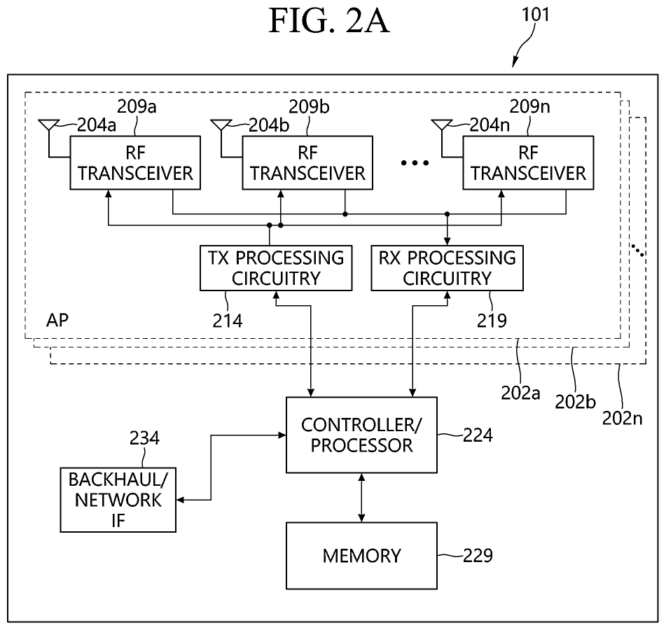

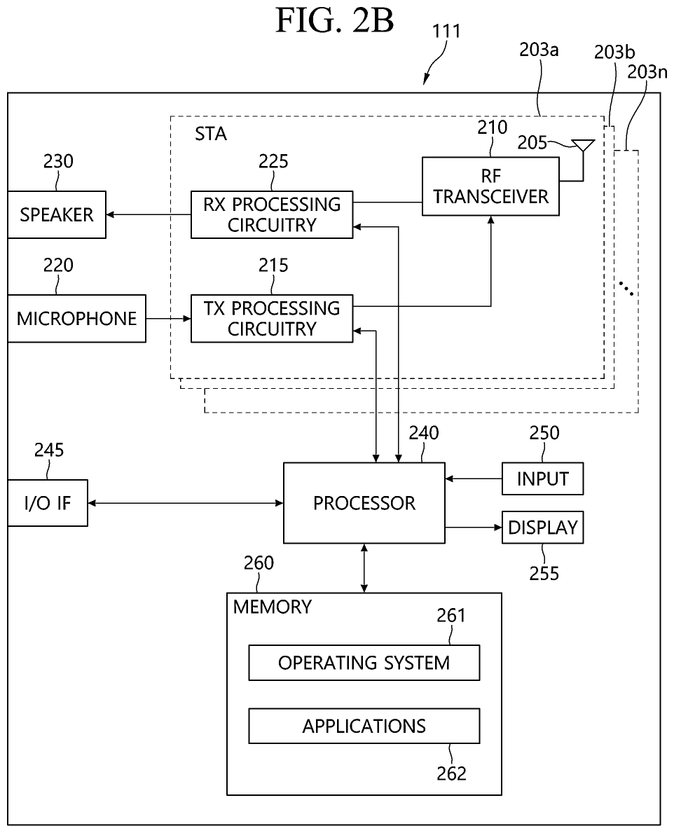

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

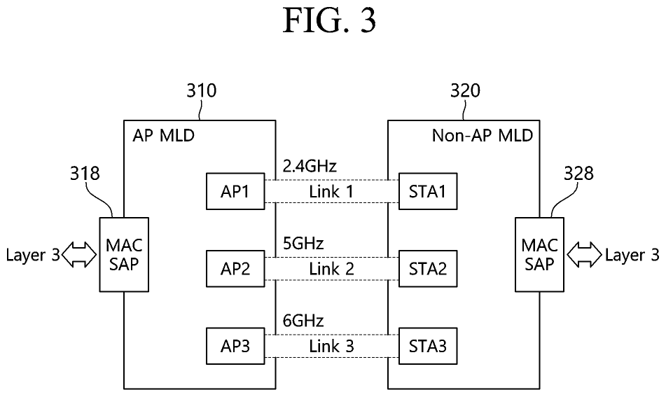

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

In a WLAN, communication between an AP and one or more of its associated non-AP STAs may take place over one or more links between the AP and the associated STAs. In particular, a frame transmission and/or reception may be communicated directly between the AP and the STA.

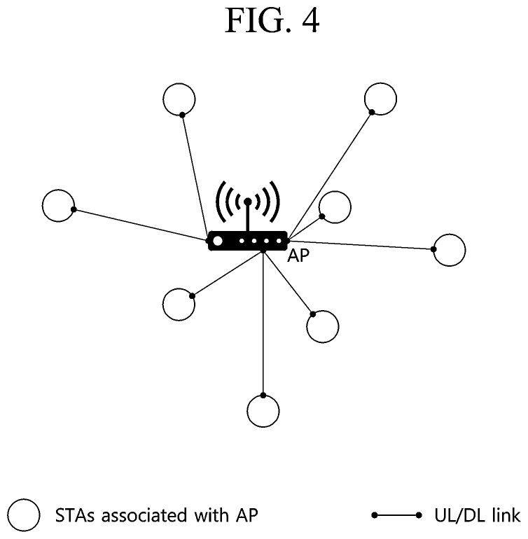

FIG. 4 illustrates a typical network infrastructure in a WLAN system in accordance with an embodiment. As illustrated, an AP may communicate with several STAs associated with the AP. For each STA associated with the AP, the AP can have an up-link and/or down-link (UL/DL) communication with the STA.

In a WLAN, a signal strength between an AP and an STA may change based on a variety of factors, including a distance between the AP and the STA. In particular, if a STA is located at a far enough distance away from its associated AP (for example, the STA can be in the cell edge), among various other reasons, the direct path between the AP and the STA may not be able to provide a sufficient signal strength as needed for communications between the AP and the STA. A received signal strength may be determined based on a received signal strength indicator (RSSI), a signal-to-noise ratio (SNR) among other indicators to ensure a required quality of service (QOS) for communications between an AP and an STA.

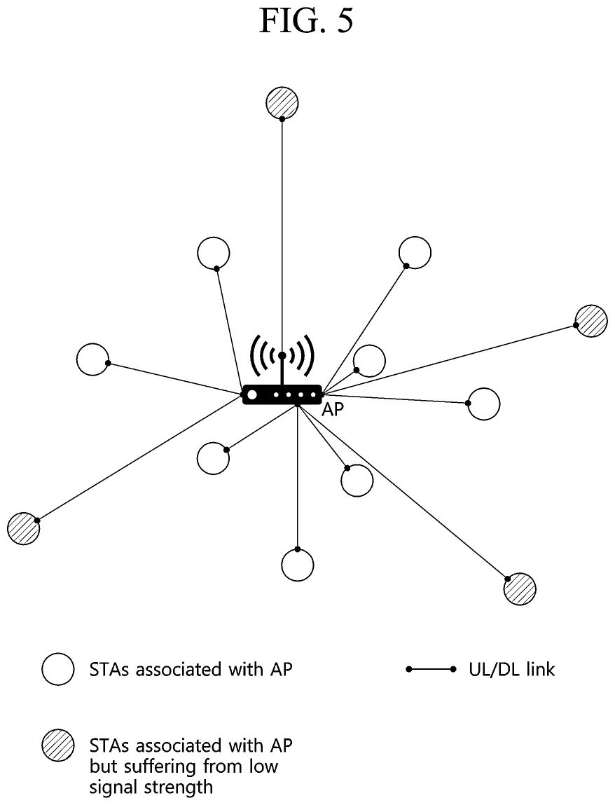

FIG. 5 illustrates a network infrastructure in a WLAN system with STAs that suffer from a low signal strength connection with an AP in accordance with an embodiment. As illustrated, an AP is associated with several STAS, and some of the STAs which are located at relatively far distances to the AP in comparison to other STAs, as illustrated according to the key in the figure, are suffering from low signal strength.

Accordingly, embodiments in accordance with this disclosure may establish one or more relay nodes between a source node and a destination node to help improve a signal strength for communications between nodes (e.g., APs and STAs) in a network.

In some embodiments, a relay node can have access point (AP) functionalities. The relay node can periodically transmit Beacon frames. The Beacon frames transmitted by a relay node may include information pertaining to the relay. In some embodiments, the Beacon frame transmitted by the relay node can include information on the availability of the relay node, including an indication of the time period during which the relay node will be available for the relaying operation. In some embodiments, the Beacon frame may include other information related to the relay node operation. In certain embodiments, any of a variety of frame types may be transmitted by the relay node for the purpose of discovery operations, including Broadcast and/or multicast frames. A relay Beacon frame format can be similar to the Beacon frame transmitted by the AP. A possible format of a Relay Beacon frame or other broadcast/multicast frame in accordance with an embodiment is set forth below in Table-I. In particular, in addition to certain standard elements that may be present in a Beacon frame, the Beacon frame may include certain additional elements related to the relay operations, including a relay capabilities field and a relay traffic indication field, as set forth below. In particular, the relay capabilities field may include information regarding the capabilities of the relay node and the relay traffic indication field may include information regarding whether a source node has information pending that needs to be delivered to the relay node.

TABLE I
Relay Beacon frame format

| Order | Information | Notes |
|---|---|---|
| 1 | Timestamp | Timestamp field format. |
| 2 | Beacon Interval | Beacon Interval field format. |
| 3 | Capability | Capability Information field format. |
| | Information | |
| 4 | Service Set - | If dot11MeshActivated is true, the SSID element is the |
| | Identifier (SSID) | wildcard value. |
| 5 | Supported | |
| | Rates and BSS | |
| | Membership | |
| | Selectors | |
| 6 | DSSS | The element is optionally present. |
| | Parameter Set | The DSSS Parameter Set element is present within Beacon |
| | | frames generated by STAs using Clause 15 (DSSS PHY |
| | | specification for the 2.4 GHz band designated for |
| | | ISM -applications), Clause 16 (High rate direct sequence spread |
| | | spectrum (HR/DSSS) PHY specification), and Clause 18 |
| | | (Extended Rate PHY (ERP) specification) PHYs. |
| | | The element is present within Beacon frames generated by |
| | | STAs in the 2.4 GHz band. |
| 7 | IBSS | The IBSS Parameter Set element is present only within Beacon |
| | Parameter Set | frames generated by IBSS STAs. |
| 8 | Traffic indication | The TIM element is present only within Beacon frames generated |
| | map (TIM) | by APs or mesh STAs. |
| 9 | Country | The Country element is present if |
| | | dot11MultiDomainCapabilityActivated is true or |
| | | dot11SpectrumManagementRequired is true or |
| | | dot11RadioMeasurementActivated is true. |
| 10 | Power Constraint | The Power Constraint element is present if |
| | | dot11SpectrumManagementRequired is true and is optionally |
| | | present if dot11RadioMeasurementActivated is true. |
| 11 | Channel Switch | The Channel Switch Announcement element is optionally |
| | Announcement | present if dot11SpectrumManagementRequired is true or |
| | | dot11ExtendedChannelSwitchActivated is true. |
| 12 | Quiet | The Quiet element is optionally present if |
| | | dot11SpectrumManagementRequired is true or |
| | | dot11RadioMeasurementActivated is true. |
| 13 | IBSS DFS | IBSS DFS element is present if |
| | | dot11SpectrumManagementRequired is true in an IBSS. |
| 14 | TPC Report | The TPC Report element is present if |
| | | dot11SpectrumManagementRequired is true or |
| | | dot11RadioMeasurementActivated is true. |
| 15 | ERP | The ERP element is present within Beacon frames generated by |
| | | STAs using extended rate PHYs (ERPs) defined in and is |
| | | optionally present in other cases. |
| 16 | Extended | The Extended Supported Rates and BSS Membership Selectors |
| | Supported | element is present if the number of supported rates and BSS |
| | Rates and BSS | membership selectors together exceed eight; it is |
| | Membership | optional otherwise. |
| | Selectors | |
| 17 | RSN | The RSNE is present if dot11RSNAActivated is true; |
| | | otherwise not present. |
| 18 | BSS Load | The BSS Load element is present if dot11QoSOptionImplemented |
| | | and dot11QBSSLoadImplemented are both true. |
| 19 | EDCA | The EDCA Parameter Set element is present if |
| | Parameter Set | dot11QoSOptionImplemented is true, dot11MeshActivated |
| | | is false, and the QoS Capability element is not present; |
| | | otherwise, it is not present. |
| 20 | QoS Capability | The QoS Capability element is present if |
| | | dot11QoSOptionImplemented is true, dot11MeshActivated |
| | | is false, and neither the EDCA Parameter Set element nor the |
| | | MU EDCA Parameter Set element is present; otherwise, |
| | | it is not present. |
| 21 | AP Channel | If dot11RMAPChannelReportActivated is true, one AP Channel |
| | Report | Report element is present for each operating class that has at |
| | | least 1 channel to report. |
| 22 | BSS Average | The BSS Average Access Delay element is present if |
| | Access Delay | dot11RMBSSAverageAccessDelayActivated is true and the AP |
| | | Average Access Delay field is not equal to 255 (measurement |
| | | not available); otherwise, the BSS Average Access Delay |
| | | element is optionally present if |
| | | dot11RMBSSAverageAccessDelayActivated is true. |
| 23 | Antenna | The Antenna element is present if |
| | | dot11RMAntennaInformationActivated is true and the Antenna |
| | | ID field is not equal to 0 (unknown antenna); otherwise, the |
| | | Antenna element is optionally present if |
| | | dot11RMAntennaInformationActivated is true. |
| 24 | BSS Available | The BSS Available Admission Capacity element is present if |
| | Admission | dot11RMBSSAvailableAdmissionCapacityActivated is true with |
| | Capacity | the following exceptions: 1) when Available Admission |
| | | Capacity Bitmask equals 0 (Available Admission Capacity List |
| | | contains no entries), or 2) when the BSS Load element is present |
| | | and the Available Admission Capacity Bitmask states that only |
| | | AC_VO is present in the Available Admission Capacity List field. |
| 25 | BSS AC | The BSS AC Access Delay element is present if |
| | Access Delay | dot11RMBSSAverageAccessDelayActivated is true and at least one |
| | | field of the element is not equal to 255 (measurement not available); |
| | | otherwise, the BSS AC Access Delay element is optionally |
| | | present if dot11RMBSSAverageAccessDelayActivated is true. |
| 26 | Measurement Pilot | The Measurement Pilot Transmission element is present if |
| | Transmission | dot11RMMeasurementPilotActivated is a value between 2 and 7. |
| 27 | Multiple BSSID | One or more Multiple BSSID elements are present if the AP is a |
| | | member of multiple BSSID set (see 11.10.14 (Multiple BSSID |
| | | set)) with two or more members and any of the following |
| | | conditions are true: |
| | | dot11MultiBSSIDImplemented is true |
| | | dot11MultiBSSIDImplemented is false and |
| | | dot11RMMeasurementPilotActivated is between 2 and 7 |
| | | dot11FILSActivated is true |
| | | dot11InterworkingServiceActivated is true and at least one |
| | | dot11GASAdvertisementID exists |
| 28 | RM Enabled | RM Enabled Capabilities element is present if |
| | Capabilities | dot11RadioMeasurementActivated is true. |
| 29 | Mobility Domain | The MDE is present if dot11FastBSSTransitionActivated is true. |
| 30 | DSE registered | The DSE Registered Location element is present if |
| | location | dot11LCIDSERequired is true. |
| 31 | Extended Channel | The Extended Channel Switch Announcement element is optionally |
| | Switch | present if dot11ExtendedChannelSwitchActivated is true. |
| | Announcement | |
| 32 | Supported | The Supported Operating Classes element is present if |
| | Operating Classes | dot11ExtendedChannelSwitchActivated or |
| | | dot11OperatingClassesRequired is true. The Supported |
| | | Operating Classes element is optionally present if |
| | | dot11TVHTOptionImplemented is true. |
| 33 | HT Capabilities | The HT Capabilities element is present when |
| | | dot11HighThroughputOptionImplemented is true and |
| | | the STA is not a STA 6G. |
| 34 | HT Operation | The HT Operation element is included by an AP and a mesh |
| | | STA when dot11HighThroughputOptionImplemented is true |
| | | and the AP or mesh STA is not a STA 6G. |
| 35 | 20/40 BSS | The 20/40 BSS Coexistence element is optionally present when |
| | Coexistence | dot112040BSSCoexistenceManagementSupport is true. |
| 36 | Overlapping BSS | The Overlapping BSS Scan Parameters element is optionally |
| | Scan Parameters | present if dot11FortyMHzOptionImplemented is true. |
| 37 | Extended | The Extended Capabilities element is present if any of |
| | Capabilities | the fields in this element are nonzero. |
| 38 | FMS Descriptor | The FMS Descriptor element is present if |
| | | dot11FMSActivated is true. |
| 39 | QoS Traffic | The QoS Traffic Capability element is optionally |
| | Capability | present if dot11ACStationCountActivated is true. |
| 40 | Time | The Time Advertisement element is present every |
| | Advertisement | dot11TimeAdvertisementDTIMInterval if |
| | | dot11UTCTSFOffsetActivated is true. |
| 41 | Interworking | The Interworking element is present if |
| | | dot11InterworkingServiceActivated is true. |
| 42 | Advertisement | Advertisement Protocol element is present if |
| | Protocol | dot11InterworkingServiceActivated is true and at least |
| | | one dot11GASAdvertisementID MIB attribute exists. |
| 43 | Roaming | The Roaming Consortium element is present if |
| | Consortium | dot11InterworkingServiceActivated is true and the |
| | | dot11RoamingConsortiumTable has at least one entry. |
| 44 | Emergency Alert | One or more Emergency Alert Identifier elements are |
| | Identifier | present if dot11EASActivated is true and there are one |
| | | or more EAS message(s) active in the network. |
| 45 | Mesh ID | The Mesh ID element is present if dot11MeshActivated is true. |
| 46 | Mesh Configuration | The Mesh Configuration element is present if |
| | | dot11MeshActivated is true. |
| 47 | Mesh Awake | The Mesh Awake Window element is optionally present if |
| | Window | dot11MeshActivated is true. |
| 48 | Beacon Timing | The Beacon Timing element is optionally present if both |
| | | dot11MeshActivated and dot11MBCAActivated are true. |
| 49 | MCCAOP | The MCCAOP Advertisement Overview element is |
| | Advertisement | optionally present if both dot11MeshActivated and |
| | Overview | dot11MCCAActivated are true. |
| 50 | MCCAOP | One or more MCCAOP Advertisement elements are |
| | Advertisement | optionally present if both dot11MeshActivated and |
| | | dot11MCCAActivated are true. |
| 51 | Mesh Channel | The Mesh Channel Switch Parameters element is |
| | Switch Parameters | present when dot11MeshActivated is true and either |
| | | Channel Switch Announcement element or Extended |
| | | Channel Switch Announcement element is present. |
| 52 | QMF Policy | Indicates the QMF policy parameters of the transmitting STA. |
| | | The QMF Policy element is present when dot11QMFActivated |
| | | is true and the transmitting STA is an AP or a mesh STA. |
| | | This element is not present otherwise. |
| 53 | QLoad Report | The QLoad Report element is present every |
| | | dot11QLoadReportIntervalDTIM DTIMs if |
| | | dot11QLoadReportActivated is true. |
| 54 | HCCA TXOP | The HCCA TXOP Update Count element is present if |
| | Update Count | both dot11PublicHCCATXOPNegotiationActivated is |
| | | true and an HC is colocated with the AP. |
| 55 | Multi-band | The Multi-band element is optionally present if |
| | | dot11MultibandImplemented is true. |
| 56 | VHT Capabilities | The VHT Capabilities element is present when |
| | | dot11VHTOptionImplemented is true and the STA is not a STA 6G. |
| 57 | VHT Operation | The VHT Operation element is present when |
| | | dot11VHTOptionImplemented is true and the STA is not a STA 6G |
| | | and is optionally present if dot11HEOptionImplemented is true; |
| | | otherwise, it is not present. |
| 58 | Transmit Power | (11ax)One Transmit Power Envelope element is present for each |
| | Envelope | distinct combination of values of the Maximum Transmit Power |
| | | Interpretation subfield and Maximum Transmit Power Category |
| | | subfield that is supported for the BSS if both of the |
| | | following conditions are met: |
| | | Either dot11VHTOptionImplemented or |
| | | dot11ExtendedSpectrumManagementImplemented is true. |
| | | Either dot11SpectrumManagementRequired is true or |
| | | dot11RadioMeasurementActivated is true. |
| | | Otherwise, this element is not present. |
| | | NOTE-In a 6 GHz HE AP, both dot11VHTOptionImplemented |
| | | and dot11SpectrumManagementRequired are true. |
| 59 | Channel Switch | The Channel Switch Wrapper element is optionally |
| | Wrapper | present if dot11VHTOptionImplemented or |
| | | dot11ExtendedSpectrumManagementImplemented is true and at |
| | | least one of a Channel Switch Announcement element or an |
| | | Extended Channel Switch Announcement element is also |
| | | present in the Beacon frame and the Channel Switch Wrapper |
| | | element contains at least one subelement. |
| 60 | Extended BSS Load | The Extended BSS Load element is optionally present |
| | | if dot11QBSSLoadImplemented, and |
| | | dot11VHTOptionImplemented are both true. |
| 61 | Quiet Channel | Either one Quiet Channel element containing an AP Quiet Mode |
| | | field equal to 0 or, in an infrastructure BSS, one or more Quiet |
| | | Channel elements each containing an AP Quiet Mode field equal |
| | | to 1 are optionally present if dot11VHTOptionImplemented is |
| | | true, and either dot11SpectrumManagementRequired |
| | | or dot11RadioMeasurementActivated is true. |
| 62 | Operating Mode | The Operating Mode Notification element is optionally present |
| | Notification | if dot11OperatingModeNotificationImplemented is true. |
| 63 | Reduced | One or more Reduced Neighbor Report elements are optionally |
| | Neighbor Report | present if dot11TVHTOptionImplemented, dot11FILSActivated, |
| | | or dot11ColocatedRNRImplemented is true; otherwise, |
| | | they are not present. |
| 64 | TVHT Operation | The TVHT Operation element is present for a TVHT STA when |
| | | dot11TVHTOptionImplemented is true; otherwise it is not present. |
| 65 | Estimated Service | The Estimated Service Parameters Inbound element is present if |
| | Parameters Inbound | dot11EstimatedServiceParametersInboundOptionImplemented is true. |
| 66 | Future Channel | The Future Channel Guidance element is optionally present if |
| | Guidance | dot11FutureChannelGuidanceActivated is true. |
| 67 | Common | The CAG Number element is optionally present if |
| | Advertisement Group | dot11FILSActivated is true; otherwise not present. |
| | (CAG) Number | |
| 68 | FILS Indication | The FILS Indication element is present if dot11FILSActivated |
| | | is true; otherwise not present. |
| 69 | AP-CSN | The AP-CSN element is optionally present if |
| | | dot11FILSActivated is true; otherwise not present. |
| 70 | DILS | The DILS element is optionally present if |
| | | dot11FILSActivated is true; otherwise not present. |
| 71 | Max Channel | The Max Channel Switch Time element is optionally present |
| | Switch Time | when a Channel Switch Announcement or an Extended Channel |
| | | Switch Announcement element is also present. |
| 72 | Estimated Services | The Estimated Service Parameters Outbound element |
| | Parameters Outbound | is optionally present if |
| | | dot11EstimatedServiceParametersOutboundOptionImplemented |
| | | is true. |
| 73 | Service Hint | The Service Hint element is optionally present if |
| | | dot11UnsolicitedPADActivated is true. |
| 74 | Service Hash | The Service Hash element is optionally present if |
| | | dot11UnsolicitedPADActivated is true. |
| 75 | RSN Extension | The RSNXE is present if any subfield of the Extended |
| | | RSN Capabilities field in this element is nonzero, |
| | | except the Field Length subfield. |
| 76 | Multiple BSSID | The Multiple BSSID Configuration element is optionally |
| | Configuration | present if dot11MultiBSSIDImplemented is true. |
| 77 | HE Capabilities | The HE Capabilities element is present if |
| | | dot11HEOptionImplemented is true; otherwise, it is not present. |
| 78 | HE Operation | The HE Operation element is present if |
| | | dot11HEOptionImplemented is true; otherwise, it is not present. |
| 79 | TWT | The TWT element is optionally present if |
| | | dot11TWTOptionActivated is true; otherwise, it is not present. |
| 80 | UORA Parameter | The UORA Parameter Set element is optionally present |
| | Set | if dot11OFDMARandomAccessOptionImplemented is |
| | | true; otherwise, it is not present. |
| 81 | BSS Color Change | The BSS Color Change Announcement element is |
| | Announcement | optionally present if dot11HEOptionImplemented is |
| | | true; otherwise, it is not present. |
| 82 | Spatial Reuse | The Spatial Reuse Parameter Set element is optionally present if |
| | Parameter Set | dot11HEOptionImplemented is true; otherwise, it is not present. |
| 83 | MU EDCA | The MU EDCA Parameter Set element is present if |
| | Parameter Set | dot11HEOptionImplemented is true, dot11MeshActivated is |
| | | false, dot11MUEDCAParametersActivated is true, and the |
| | | QoS Capability element is not present; otherwise, it is |
| | | not present. |
| 84 | ESS Report | The ESS Report element is optionally present. |
| 85 | NDP | The NDP Feedback Report Parameter Set element is |
| | Feedback Report | optionally present if dot11HEOptionImplemented is |
| | Parameter Set | true; otherwise, it is not present. |
| 86 | HE BSS Load | The HE BSS Load element is optionally present if |
| | | dot11QBSSLoadImplemented and |
| | | dot11HEOptionImplemented are true. |
| 87 | HE 6 GHz Band | The HE 6 GHz Band Capabilities element is present if |
| | Capabilities | dot11HEOptionImplemented and |
| | | dot11HE6GOptionImplemented are true. |
| 88 | TWT Constraint | The TWT Constraint Parameters element is optionally present if |
| | Parameters | dot11TWTOptionActivated is true; otherwise, it is not present. |
| 89 | WUR Capabilities | The WUR Capabilities element is present when |
| | | dot11WUROptionImplemented is true; otherwise it is not present. |
| 90 | WUR Operation | The WUR Operation element is present when |
| | | dot11WUROptionImplemented is true; otherwise it is not present. |
| 91 | WUR Discovery | The WUR Discovery element is optionally present |
| | | if dot11WUROptionImplemented is true and either |
| | | dot11WURDiscoveryImplemented or |
| | | dot11WURNeighborDiscoveryImplemented is true; |
| | | otherwise it is not present. |
| Last - 1 | Vendor Specific | One or more Vendor Specific elements are optionally present. |
| Last | MME | The MME is present if dot11BeaconProtectionEnabled |
| | | is true at the AP. |

NOTE-
The MME appears after all fields that it protects. Therefore, it appears last in the frame body to protect the frames as specified in 12.5.3 (Broadcast/multicast integrity protocol (BIP)).

In some embodiments, the relay Beacon frame may also include the below information.

| Order | Information | Notes |
|---|---|---|
| . . . | | |
| 12 | Quiet | The Quiet element is optionally present if |
| | | dot11SpectrumManagementRequired is true |
| | | or dot11RadioMeasurementActivated is true |
| | | or dot11RestrictedTWTOptionImplemented |
| | | is true. |
| . . . | | |
| 79 | TWT | The TWT element is optionally present if |
| | | dot11TWTOptionActivated is true. The |
| | | TWT element is present if the |
| | | dot11RestrictedTWTOptionImplemented |
| | | is true and the AP has at least one R- |
| | | TWT schedule as described in 35.8.3 |
| | | (R-TWT announcement; otherwise, |
| | | it is not present. |
| . . . | | |
| <Last | Multi-Link | If dot11MultiLinkActivated is true, the |
| assigned + | | Basic Multi-Link element is present and the |
| 1> | | Reconfiguration Multi-Link element is |
| | | optionally present; otherwise Multi-Link |
| | | element is not present. |
| <Last | EHT | The EHT Capabilities element is present if |
| assigned + | Capabilities | dot11EHTOptionImplemented is true; |
| 2> | | otherwise it is not present. |
| <Last | EHT | The EHT Operation element is present if |
| assigned + | Operation | dot11EHTOptionImplemented is true; |
| 3> | | otherwise it is not present. |
| <Last | Multi-Link | The Multi-Link Traffic Indication element |
| assigned + | Traffic | is present if |
| 4> | Indication | dot11MultiLinkTrafficIndicationActivated |
| | | is true; other- wise it is not present. |
| <Last | TID-To-Link | One or two TID-To-Link Mapping elements |
| assigned + | Mapping | are optionally present if |
| 5> | | dot11MultiLinkActivated and |
| | | dot11TIDtoLinkMappingActivated are true; |
| | | otherwise, none are present. |
| <Last | Relay | The Relay Capabilities element contains a |
| assigned + | Capabilities | set of information pertaining to the |
| 6> | | capabilities of the relay node. |
| <Last | Relay Traffic | The Relay Traffic Indication element |
| assigned + | Indication | contains a set of information that |
| 7> | | indicates whether the source node has |
| | | information pending that needs |
| | | to be delivered to the relay node. |

In some embodiments, if a node supports acting as a relay node in the relay operation, it sets a particular management information base (MIB) variable to 1. For example, the name of the MIB variable can be dot11RelayActivated. In this example, if a WLAN node supports acting as a relay node in the relay operation, it can set the dot11RelayActivated variable to 1.

In some embodiments, a WLAN node that supports relay operations either as a source node, a destination node, or as a relay node in the relay operation process may set a MIB variable, e.g. dot11RelayOperationSupported, to 1. Otherwise, the node may set that MIB variable to 0.

In some embodiments, a WLAN node that supports relay operations as a source node can set a MIB variable, e.g., dot11RelaySourceNodeSupported, to 1; Otherwise, it can set the MIB variable to 0.

In some embodiments, a WLAN node that supports relay operations as a destination node can set an MIB variable, e.g., dot11RelayDestinationNodeSupported, to 1; Otherwise, it can set the MIB variable to 0.

In some embodiments, in order to operate as a relay node, the relay node can associate with the source node. In some embodiments, the source node can be an AP or a non-AP STA.

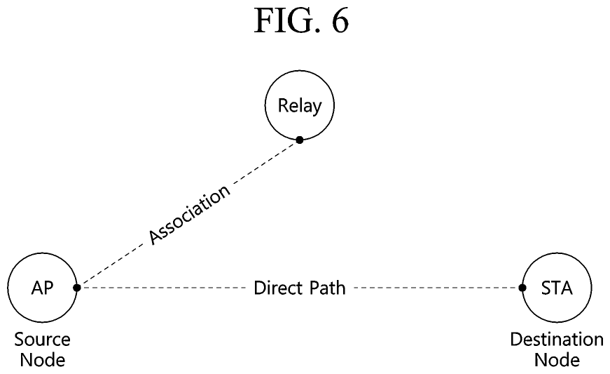

FIG. 6 illustrates association of a relay node with a source node in accordance with an embodiment. As illustrated, an STA, which is a destination node, is associated with and has a direct path with an AP, which is a source node. Furthermore, a relay node is associated with the source node (e.g., AP).

In some embodiments, in order to operate as a relay node, the relay node can associate with the destination node. In some embodiments, the destination node can be an AP or a non-AP STA.

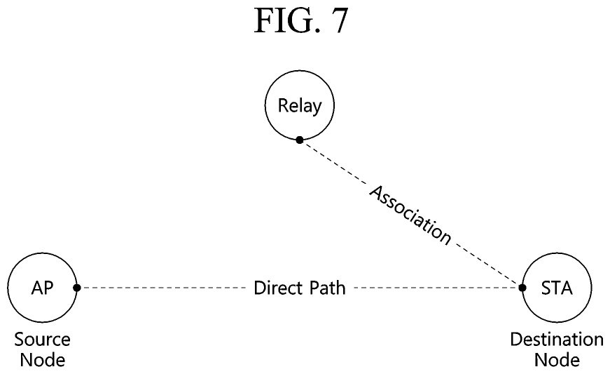

FIG. 7 illustrates association of a relay node with a destination node in accordance with an embodiment. AS illustrated, an AP, which is a source node, is associated with and has a direct path with an STA, which is a destination node. Furthermore, a relay node is associated with the destination node (e.g., STA).

In some embodiments, in order to operate as a relay node, the relay node can associate with both the source node and the destination node. In some embodiments, the source node or the destination node can be an AP or a non-AP STA.

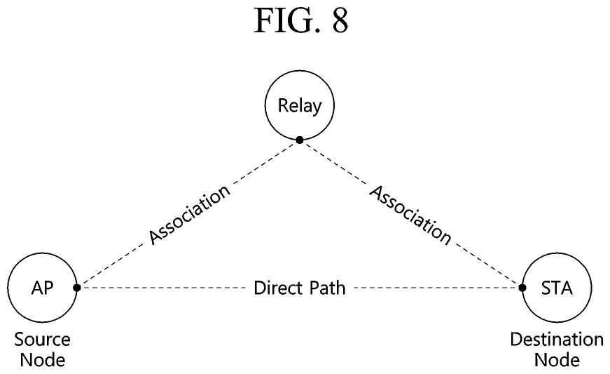

FIG. 8 illustrates association of a relay node with both a source node and a destination node in accordance with an embodiment. As illustrated, an AP, which is a source node, is associated with and has a direct path with an STA, which is a destination node. Furthermore, a relay node is associated with both the source node (e.g., AP) and the destination node (e.g., STA).

In some embodiments, in order to seek relay information from a relay node, the source node and/or the destination node can send a Relay Discovery Request frame to the relay node. Upon receiving a Relay Discovery Request frame from the source node or the destination node, the relay node can send, in response, a Relay Discovery Response frame to the requester (e.g., the source node or the destination node). In some embodiments, the format of the Relay Discovery Request frame or the Relay Discovery Response frame can be the same as the format of a Probe Request frame or Probe Response frame that may be exchanged between an AP and a non-AP STA.

In some embodiments, in order to set up a relay link between the relay node or the source node, the source node or the relay node can send a Relay Association Request frame to the relay node or the source node.

In some embodiments, in order to set up a relay link between the relay node or the destination node, the destination node or the relay node can send a Relay Association Request frame to the relay node or the destination node.

A possible format of a Relay Association Request frame in accordance with an embodiment is shown in Table-II. The Relay Association Request frame may include certain standard fields and other additional fields related to relay operations, including an SIG Relay field, a Reachable Address field, and a SIG Relay Activation field, as described below.

TABLE II
Relay Association Request frame body

| Order | Information | Notes |
|---|---|---|
| 1 | Capability | See 9.4.1.4 (Capability Information field) for |
| | Information | Capability Information field format. |
| 2 | Listen Interval | |
| 3 | SSID | |
| 4 | Supported | If dot11S1GOptionImplemented or |
| | Rates and BSS | dot11DMGOptionImplemented is true, this element ought |
| | Membership | not be present unless one or more BSS membership |
| | Selectors | selectors (see 11.1.4.6 (Operation of Supported Rates |
| | | and BSS Membership Selectors element and Extended |
| | | Supported Rates and BSS Membership Selectors |
| | | element) are indicated. |
| 5 | Extended Supported | The Extended Supported Rates and BSS Membership |
| | Rates and BSS | Selectors element is present if the number of supported |
| | Membership | rates and BSS membership selectors together exceed |
| | Selectors | eight; it is optional otherwise. |
| | | If dot11S1GOptionImplemented or |
| | | dot11DMGOptionImplemented is true, this element |
| | | ought not be present unless there are more than 8 BSS |
| | | membership selectors (see 11.1.4.6 (Operation of |
| | | Supported Rates and BSS Membership Selectors element |
| | | and Extended Supported Rates and BSS Membership |
| | | Selectors element) indicated. |
| 6 | Power Capability | The Power Capability element is present if |
| | | dot11SpectrumManagementRequired is true or |
| | | dot11RadioMeasurementActivated is true. |
| 7 | Supported Channels | The Supported Channels element is present if |
| | | dot11SpectrumManagementRequired is true and |
| | | dot11ExtendedChannelSwitchActivated is false. The |
| | | Supported Channels element is optionally present, otherwise. |
| 8 | RSN | The RSNE is present if dot11RSNAActivated is |
| | | true; otherwise not present. |
| 9 | QoS Capability | The QoS Capability element is present if |
| | | dot11QoSOptionImplemented is true. |
| 10 | RM Enabled | RM Enabled Capabilities element is present if |
| | Capabilities | dot11RadioMeasurementActivated is true. |
| 11 | Mobility Domain | The MDE is present in an Association Request |
| | | frame if dot11FastBSSTransitionActivated is true |
| | | and if the frame is being sent to an AP that |
| | | advertised its FT capability in the MDE in its |
| | | Beacon or Probe Response frame (i.e., AP also has |
| | | dot11FastBSSTransitionActivated equal to true). |
| 12 | Supported Operating | The Supported Operating Classes element is |
| | Classes | present if dot11ExtendedChannelSwitchActivated |
| | | or dot11OperatingClassesRequired is true. |
| 13 | HT Capabilities | The HT Capabilities element is present when |
| | | dot11HighThroughputOptionImplemented is true |
| | | and the STA is not a STA 6G.(11ax) |
| 14 | 20/40 BSS | The 20/40 BSS Coexistence element is optionally present when |
| | Coexistence | dot112040BSSCoexistenceManagementSupport is true. |
| 15 | Extended Capabilities | The Extended Capabilities element is present if any |
| | | of the fields in this element are nonzero. |
| 16 | QoS Traffic | The QoS Traffic Capability element is present if |
| | Capability | dot11QoSTrafficCapabilityActivated is true. |
| 17 | TIM Broadcast | The TIM Broadcast Request element is present if |
| | Request | dot11TIMBroadcastActivated is true. |
| 18 | Interworking | The Interworking element is present if |
| | | dot11InterworkingServiceActivated is true and the |
| | | non-AP STA is requesting unauthenticated access |
| | | to emergency services (see 11.3.5 (Association, |
| | | reassociation, and disassociation)). |
| 19 | Multi-band | The Multi-band element is optionally present if |
| | | dot11MultibandImplemented is true. |
| 20 | DMG Capabilities | The DMG Capabilities element is present if |
| | | dot11DMGOptionImplemented is true. |
| 21 | Multiple MAC | The Multiple MAC Sublayers element is present if |
| | Sublayers | dot11MultipleMACActivated is true. |
| 22 | VHT Capabilities | The VHT Capabilities element is present when |
| | | dot11VHTOptionImplemented is true and the STA |
| | | is not a STA 6G.(11ax) |
| 23 | Operating Mode | The Operating Mode Notification element is optionally |
| | Notification | present if dot11OperatingModeNotificationImplemented |
| | | is true. |
| 24 | FILS Session | The FILS Session element is optionally present if |
| | | dot11FILSActivated is true; otherwise not present. |
| 25 | FILS Public Key | The FILS Public Key element is present if |
| | | dot11FILSActivated is true and FILS Public Key |
| | | authentication is used; otherwise not present. |
| 26 | FILS Key | The FILS Key Confirmation element is present if |
| | Confirmation | dot11FILSActivated is true and FILS authentication |
| | | is used; otherwise not present. |
| 27 | FILS HLP | One or more FILS HLP Container elements are |
| | Container | optionally present if dot11FILSActivated is true; |
| | | otherwise not present. |
| 28 | FILS IP Address | The FILS IP Address Assignment element is |
| | Assignment | optionally present if dot11FILSActivated is true; |
| | | otherwise not present. |
| 29 | TWT | The TWT element is optionally present if |
| | | dot11TWTOptionActivated is true; otherwise not present. |
| 30 | AID Request | The AID Request element is optionally present if |
| | | dot11S1GOptionImplemented is true; otherwise not present. |
| 31 | S1G Capabilities | The SIG Capabilities element is present if |
| | | dot11S1GOptionImplemented is true; otherwise not present. |
| 32 | EL Operation | The EL Operation element is optionally present if |
| | | dot11S1GELOperationActivated is true; otherwise |
| | | not present. |
| 33 | S1G Relay | The S1G Relay element is present if |
| | | dot11RelaySTAImplemented is true; otherwise not present. |
| 34 | BSS Max | The BSS Max Idle Period element is optionally present |
| | Idle Period | if dot11WirelessManagementImplemented and |
| | | dot11BSSMaxIdlePeriodIndicationByNonAPSTA are true, |
| | | or if dot11S1GOptionImplemented is true; |
| | | otherwise not present. |
| 35 | Header Compression | The Header Compression element is present if |
| | | dot11PV1MACHeaderOptionImplemented is true. |
| 36 | MAD | The MAD element is optionally present if |
| | | dot11S1GOptionImplemented is true; otherwise |
| | | not present. |
| 37 | Reachable Address | The Reachable Address element is optionally present if |
| | | dot11RelaySTAImplemented is true; otherwise not present. |
| 38 | S1G Relay Activation | The S1G Relay Activation element is optionally present if |
| | | dot11RelaySTAImplemented is true; otherwise not present. |
| 39 | CDMG Capabilities | The CDMG Capabilities element is present if |
| | | dot11CDMGOptionImplemented is true; |
| | | otherwise not present. |
| 40 | CMMG Capabilities | The CMMG Capabilities element is present when |
| | | dot11CMMGOptionImplemented is true; |
| | | otherwise not present. |
| 41 | GLK-GCR | The GLK-GCR Parameter Set element is present if |
| | Parameter Set | dot11GLKImplemented is true to indicate the number of |
| | | reorder buffers the STA has to support GLK-GCR with |
| | | GCR block ack and respond to corresponding GLK-GCR |
| | | BlockAckReq frames. Otherwise this element is not present. |
| 42 | Fast BSS Transition | An FTE is present in an Association Request frame |
| | | if dot11FastBSSTransitionActivated is true, |
| | | dot11RSNAAuthenticationSuiteSelected is 00-0F-AC:16 |
| | | or 00-0F-AC:17, and FT initial mobility domain |
| | | association over FILS in an RSN is being performed. |
| 43 | RSN Extension | The RSNXE is present if any subfield of the |
| | | Extended RSN Capabilities field in this element is |
| | | nonzero, except the Field Length subfield. |
| 44 | Supplemental Class | The Supplemental Class 2 Capabilities element is present |
| | 2 Capabilities | when dot11Class2CapabilitiesOptionImplemented is |
| | | true; otherwise not present. |
| 45 | MSCS Descriptor | The MSCS Descriptor element is optionally present if |
| | | dot11MSCSActivated is true; otherwise not present. |
| 46(11ax) | HE Capabilities | The HE Capabilities element is present if |
| | | dot11HEOptionImplemented is true; otherwise, it |
| | | is not present. |
| 47(11ax) | Channel Switch | The Channel Switch Timing element is optionallypresent |
| | Timing | if dot11HESubchannelSelectiveTransmissionImplemented |
| | | is true; otherwise, it is not present. |
| 48(11ax) | HE 6 GHz Band | The HE 6 GHz Band Capabilities element is |
| | Capabilities | present if dot11HEOptionImplemented and |
| | | dot11HE6GOptionImplemented are true; |
| | | otherwise, it is not present. |
| 49(11ax) | UL MU Power | The UL MU Power Capabilities element is |
| | Capabilities | optionally present if dot11HEOptionImplemented |
| | | is true; otherwise, it is not present. |
| 50(11ax) | TWT Constraint | The TWT Constraint Parameters element is |
| | Parameters | optionally present if dot11TWTOptionActivated is |
| | | true; otherwise, it is not present. |
| 51(11ay) | EDMG Capabilities | The EDMG Capabilities element is present if |
| | | dot11EDMGOptionImplemented is true. |
| 52(11ay) | QoS Triggered | The QoS Triggered Unscheduled element is optionally |
| | Unscheduled | present if dot11EDMGOptionImplemented is true. |
| 53(11ay) | Unsolicited Block | The Unsolicited Block Ack Extension element is |
| | Ack Extension | optionally present if dot11UnsolicitedBAActivated is |
| | | true and is absent otherwise. |
| 54(11ay) | TDD Slot | The TDD Slot Schedule element is optionally |
| | Schedule | present if dot11DMGOptionImplemented is true. |
| 55(11ay) | TDD Route | This element is optionally present if |
| | | dot11TDDOptionImplemented is true; otherwise, |
| | | not present. If present, the element specifies the |
| | | TDD beamforming results. |
| 56(11ba) | WUR Capabilities | The WUR Capabilities element is present when |
| | | dot11WUROptionImplemented is true; otherwise |
| | | it is not present. |
| 57(11ba) | WUR Mode | The WUR Mode element is optionally present |
| | | when dot11WUROptionImplemented is true; |
| | | otherwise, it is not present. |
| 58 | Diffie-Hellman | The Diffie-Hellman Parameter element is optionally |
| | Parameter | present when performing OWE; otherwise it is not present. |
| Last | Vendor Specific | One or more Vendor Specific elements are optionally |
| | | present. These elements follow all other elements. |

In some embodiments, upon receiving a Relay Association Request frame from the relay node or the source node, the source node or the relay node can send a Relay Association Response frame to the relay node or the source node.

In some embodiments, upon receiving a Relay Association Request frame from the relay node or the destination node, the destination node or the relay node can send a Relay Association Response frame to the relay node or the destination node.

A possible format of a Relay Association Response frame in accordance with an embodiment is shown in Table-III. The Relay Association Response frame may include certain standard fields and other additional fields related to relay operations, including an S1G Relay field and an S1G Relay Activation field, as described below.

TABLE III
Relay Association Response frame body

| Order | Information | Notes |
|---|---|---|
| 1 | Capability | See 9.4.1.4 (Capability Information field) for |
| | Information | Capability Information field format. |
| 2 | Status Code | |
| 3 | AID | This field is not present when |
| | | dot11S1GOptionImplemented is true. |
| 4 | Supported Rates and | If dot11S1GOptionImplemented or |
| | BSS Membership | dot11DMGOptionImplemented is true, this |
| | Selectors | element ought not be present unless one or more |
| | | BSS membership selectors (see 11.1.4.6 |
| | | (Operation of Supported Rates and BSS |
| | | Membership Selectors element and Extended |
| | | Supported Rates and BSS Membership Selectors |
| | | element) are indicated. |
| 5 | Extended Supported | The Extended Supported Rates and BSS |
| | Rates and BSS | Membership Selectors element is present if the |
| | Membership Selectors | number of supported rates and BSS membership |
| | | selectors together exceed eight; it is optional |
| | | otherwise. |
| | | If dot11S1GOptionImplemented or |
| | | dot11DMGOptionImplemented is true, this |
| | | element ought not be present unless there are more |
| | | than 8 BSS membership selectors (see 11.1.4.6 |
| | | (Operation of Supported Rates and BSS |
| | | Membership Selectors element and Extended |
| | | Supported Rates and BSS Membership Selectors |
| | | element) indicated. |
| 6 | EDCA Parameter Set | The EDCA Parameter Set element is present if |
| | | dot11QosOptionImplemented is true; otherwise |
| | | not present. |
| 7 | RCPI | The RCPI element is present if |
| | | dot11RMRCPIMeasurementActivated is true. |
| 8 | RSNI | The RSNI element is present if |
| | | dot11RMRSNIMeasurementActivated is true. |
| 9 | RM Enabled | RM Enabled Capabilities element is present if |
| | Capabilities | dot11RadioMeasurementActivated is true. |
| 10 | RSN | The RSNE is present if dot11FILSActivated is |
| | | true; otherwise not present. |
| 11 | Mobility Domain | An MDE is present in an Association Response |
| | | frame when dot11FastBSSTransitionActivated is |
| | | true and this frame is a response to an Association |
| | | Request frame that contained an MDE (i.e., an FT |
| | | initial mobility domain association exchange). |
| 12 | Fast BSS Transition | An FTE is present in an Association Response |
| | | frame when dot11FastBSSTransitionActivated is |
| | | true, dot11RSNAActivated is true, and this frame |
| | | is a response to an Association Request frame that |
| | | contained an MDE (i.e., an FT initial mobility |
| | | domain association exchange in an RSN). |
| 13 | DSE registered | The DSE Registered Location element is present |
| | location | if dot11LCIDSERequired is true. |
| 14 | Timeout Interval | A TIE containing the association comeback time |
| | (association | is present when dot11RSNAActivated is true, |
| | comeback time) | dot11RSNAProtectedManagementFramesActivated |
| | | is true, and either the association request is |
| | | rejected with a status code |
| | | REFUSED_TEMPORARILY or the association |
| | | request is accepted with a status code 0 and when |
| | | dot11S1GOptionImplemented is true. |
| 15 | HT Capabilities | The HT Capabilities element is present when |
| | | dot11HighThroughputOptionImplemented is true |
| | | and the STA is not a STA 6G.(11ax) |
| 16 | HT Operation | The HT Operation element is included by an AP |
| | | and a mesh STA when |
| | | dot11HighThroughputOptionImplemented is true |
| | | and the STA is not a STA 6G.(11ax) |
| 17 | 20/40 BSS | The 20/40 BSS Coexistence element is optionally |
| | Coexistence | present when |
| | | dot112040BSSCoexistenceManagementSupport |
| | | is true. |
| 18 | Overlapping BSS | The Overlapping BSS Scan Parameters element is |
| | Scan Parameters | optionally present if |
| | | dot11FortyMHzOptionImplemented is true. |
| 19 | Extended Capabilities | The Extended Capabilities element is present if |
| | | any of the fields in this element are nonzero. |
| 20 | BSS Max Idle Period | The BSS Max Idle Period element is present if |
| | | dot11WirelessManagementImplemented is true |
| | | and the BSS max idle period is nonzero, or |
| | | optionally present if |
| | | dot11S1GOptionImplemented is true. |
| 21 | TIM Broadcast | The TIM Broadcast Response element is present |
| | Response | if dot11TIMBroadcastActivated is true and the TIM |
| | | Broadcast Request element is present in the |
| | | Association Request frame that elicited this |
| | | Association Response frame. |
| 22 | QoS Map | The QoS Map element is present if |
| | | dot11QosMapActivated is true and the QoS Map |
| | | field in the Extended Capabilities element of the |
| | | corresponding Association Request frame is 1. |
| 23 | QMF Policy | The QMF Policy element is present if |
| | | dot11QMFActivated is true and the |
| | | QMFActivated subfield is 1 in the Extended |
| | | Capabilities element in the Association Request |
| | | frame that elicited this Association Response |
| | | frame. |
| 24 | Multi-band | The Multi-band element is optionally present if |
| | | dot11MultibandImplemented is true. |
| 25 | DMG Capabilities | The DMG Capabilities element is present if |
| | | dot11DMGOptionImplemented is true. |
| 26 | DMG Operation | The DMG Operation element is present if |
| | | dot11DMGOptionImplemented is true. |
| 27 | Multiple MAC | The Multiple MAC Sublayers element is present |
| | Sublayers | if dot11MultipleMACActivated is true. |
| 28 | Neighbor Report | One or more Neighbor Report elements is present |
| | | if the Status Code field is |
| | | REJECTED_WITH_SUGGESTED_BSS_TRANSITION. |
| 29 | VHT Capabilities | The VHT Capabilities element is present when |
| | | dot11VHTOptionImplemented is true and the |
| | | STA is not a STA 6G.(11ax) |
| 30 | VHT Operation | The VHT Operation element is present when |
| | | dot11VHTOptionImplemented is true and the |
| | | STA is not a STA 6G and is optionally present if |
| | | dot11HEOptionImplemented is true; otherwise, it |
| | | is not present. (11ax) |
| 31 | Operating Mode | The Operating Mode Notification element is |
| | Notification | optionally present if |
| | | dot11OperatingModeNotificationImplemented is |
| | | true. |
| 32 | Future Channel | The Future Channel Guidance element is |
| | Guidance | optionally present if |
| | | dot11FutureChannelGuidanceActivated is true. |
| 33 | FILS Session | The FILS Session element is present if |
| | | dot11FILSActivated is true; otherwise not |
| | | present. |
| 34 | FILS Public Key | The FILS Public Key element is present if |
| | | dot11FILSActivated is true and FILS Public Key |
| | | authentication is used; otherwise not present. |
| 35 | FILS Key | The FILS Key Confirmation element is present if |
| | Confirmation | dot11FILSActivated is true and FILS |
| | | authentication is used; otherwise not present. |
| 36 | FILS HLP Container | One or more FILS HLP Container elements are |
| | | optionally present if dot11FILSActivated is true; |
| | | otherwise not present. |
| 37 | FILS IP Address | The FILS IP Address Assignment element is |
| | Assignment | optionally present if dot11FILSActivated is true; |
| | | otherwise not present. |
| 38 | Key Delivery | The Key Delivery element is present if |
| | | dot11FILSActivated is true; otherwise not |
| | | present. |
| 39 | S1G Sector Operation | The S1G Sector Operation element is optionally |
| | | present if dot11S1GSectorizationActivated is |
| | | true; otherwise not present. |
| 40 | TWT | The TWT element is present if |
| | | dot11TWTOptionActivated is true and the TWT |
| | | element is present in the Association Request |
| | | frame that elicited this Association Response |
| | | frame. |
| | | (11ax)The TWT element is optionally present if |
| | | dot11TWTOptionActivated is true, |
| | | dot11HEOptionImplemented is true, and the |
| | | TWT Requester Support field in the HE |
| | | Capabilities element in the Association Request |
| | | frame that elicited this Association Response |
| | | frame is 1. |
| | | (11ax)Otherwise, the TWT element is not present. |
| | | (11ax)If the TWT element is present in the |
| | | Association Request frame that solicits the |
| | | Association Response frame but the TWT |
| | | element is not present in the Association |
| | | Response frame, then the STA can transmit |
| | | another TWT request frame after association. |
| 41 | TSF Timer Accuracy | The TSF Timer Accuracy element is optionally |
| | | present when dot11TSFTimerAccuracyImplemented |
| | | is true; otherwise not present. |
| 42 | S1G Capabilities | The S1G Capabilities element is present if |
| | | dot11S1GOptionImplemented is true; otherwise |
| | | not present. |
| 43 | S1G Operation | The S1G Operation element is present if |
| | | dot11S1GOptionImplemented is true; otherwise |
| | | not present. |
| 44 | AID Response | The AID Response element is present when |
| | | dot11S1GOptionImplemented is true. |
| 45 | Sectorized Group ID | The Sectorized Group ID List element is |
| | List | optionally present when |
| | | dot11S1GSectorizationActivated is true; |
| | | otherwise not present. |
| 46 | S1G Relay | The S1G Relay element is optionally present if |
| | | dot11RelayAPImplemented is true; otherwise not |
| | | present. |
| 47 | Header Compression | The Header Compression element is present if |
| | | dot11PV1MACHeaderOptionImplemented is true. |
| 48 | SST Operation | The SST Operation element is present if |
| | | dot11SelectiveSubchannelTransmissionPermitted |
| | | is true. |
| 49 | MAD | The MAD element is optionally present if |
| | | dot11S1GOptionImplemented is true; otherwise |
| | | not present. |
| 50 | S1G Relay Activation | The S1G Relay Activation element is optionally |
| | | present if dot11RelaySTAImplemented is true; |
| | | otherwise not present. |
| 51 | CDMG Capabilities | The CDMG Capabilities element is present if |
| | | dot11CDMGOptionImplemented is true; |
| | | otherwise not present. |
| 52 | CMMG Capabilities | The CMMG Capabilities element is present when |
| | | dot11CMMGOptionImplemented is true; |
| | | otherwise not present. |
| 53 | CMMG Operation | The CMMG Operation element is present when |
| | | dot11CMMGOptionImplemented is true; |
| | | otherwise not present. |
| 54 | GLK-GCR Parameter | The GLK-GCR Parameter Set element is present |
| | Set | if dot11GLKimplemented is true and the AP has |
| | | set up a GLK-GCR for group transmissions over |
| | | the underlying general link. Otherwise this |
| | | element is not present. |
| 55 | RSN Extension | The RSNXE is present if any subfield of the |
| | | Extended RSN Capabilities field in this element is |
| | | nonzero, except the Field Length subfield. |
| 56 | MSCS Descriptor | The MSCS Descriptor element is optionally |
| | | present if dot11MSCSActivated is true; otherwise |
| | | not present. |
| 57 (11ax) | HE Capabilities | The HE Capabilities element is present if |
| | | dot11HEOptionImplemented is true; otherwise, it |
| | | is not present. |
| 58 (11ax) | HE Operation | The HE Operation element is present if |
| | | dot11HEOptionImplemented is true; otherwise, it |
| | | is not present. |
| 59 (11ax) | BSS Color Change | The BSS Color Change Announcement element is |
| | Announcement | optionally present if dot11HEOptionImplemented |
| | | is true; otherwise, it is not present. |
| 60 (11ax) | Spatial Reuse | The Spatial Reuse Parameter Set element is |
| | Parameter Set | optionally present if dot11HEOptionImplemented |
| | | is true; otherwise, it is not present. |
| 61 (11ax) | MU EDCA Parameter | The MU EDCA Parameter Set element is present |
| | Set | if dot11HEOptionImplemented and |
| | | dot11MUEDCAParametersActivated are true; |
| | | otherwise, it is not present. |
| 62 (11ax) | UORA Parameter Set | The UORA Parameter Set element is optionally |
| | | present if dot11HEOptionImplemented is true; |
| | | otherwise, it is not present. |
| 63 (11ax) | ESS Report | The ESS Report element is optionally present. |
| 64 (11ax) | NDP Feedback Report | The NDP Feedback Report Parameter Set element |
| | Parameter Set | is optionally present if dot11HEOptionImplemented |
| | | is true; otherwise, it is not present. |
| 65 (11ax) | HE 6 GHz Band | The HE 6 GHz Band Capabilities element is |
| | Capabilities | present if dot11HEOptionImplemented and |
| | | dot11HE6GOptionImplemented are true. |
| 66 (11ax) | TWT Constraint | The TWT Constraint Parameters element is |
| | Parameters | optionally present if dot11TWTOptionActivated |
| | | is true; otherwise, it is not present. |
| 67(11ay) | EDMG Capabilities | The EDMG Capabilities element is present if |
| | | dot11EDMGOptionImplemented is true. |
| 68(11ay) | EDMG Operation | The EDMG Operation element is present if |
| | | dot11EDMGOptionImplemented is true. |
| 69(11ay) | QoS Triggered | The QoS Triggered Unscheduled element is optionally |
| | Unscheduled | present if dot11EDMGOptionImplemented is true. |
| 70(11ay) | Unsolicited Block | The Unsolicited Block Ack Extension element is |
| | Ack Extension | optionally present if dot11UnsolicitedBAActivated |
| | | is true and is absent otherwise. |
| 71(11ay) | TDD Slot Structure | The TDD Slot Structure element is optionally |
| | | present if dot11DMGOptionImplemented is true. |
| 72(11ay) | TDD Slot Schedule | The TDD Slot Schedule element is optionally |
| | | present if dot11DMGOptionImplemented is true. |
| 73(11ay) | TDD Route | This element is optionally present if |
| | | dot11TDDOptionImplemented is true; otherwise, |
| | | not present. If present, the element specifies the |
| | | TDD sector switch configuration. |
| 74(11ba) | WUR Capabilities | The WUR Capabilities element is present when |
| | | dot11WUROptionImplemented is true; otherwise |
| | | it is not present. |
| 75(11ba) | WUR Operation | The WUR Operation element is present when |
| | | dot11WUROptionImplemented is true; otherwise |
| | | it is not present. |
| 76(11ba) | WUR Mode | The WUR Mode element is present when |
| | | dot11WUROptionImplemented is true, and the |
| | | WUR Mode element is present in the Association |
| | | Request frame that solicited this Association |
| | | Response frame; otherwise it is not present. |
| 77 | Diffie-Hellman | The Diffie-Hellman Parameter element is |
| | Parameter | optionally present when performing OWE; |
| | | otherwise it is not present. |
| Last | Vendor Specific | One or more Vendor Specific elements are |
| | | optionally present. These elements follow all |
| | | other elements. |

In some embodiments, a relay node and a source node/destination node can also exchange a Relay Reassociation Request frame and a Relay Reassociation Response frame to support mobility or temporary relay link disablement. A format of these frame in accordance with an embodiment are shown in Table IV and Table V. The Relay Reassociation Request frame and Relay Reassociation Response frame may include certain standard fields and other additional fields related to relay operations, including an SIG Relay field and an SIG Relay Activation field, as described below.

TABLE IV
Relay Reassociation Request frame body

| Order | Information | Notes |
|---|---|---|
| 1 | Capability | See 9.4.1.4 (Capability Information field) for |
| | Information | Capability Information field format. |
| 2 | Listen Interval | |
| 3 | Current AP address | |
| 4 | SSID | |
| 5 | Supported Rates and | If dot11S1GOptionImplemented or |
| | BSS Membership | dot11DMGOptionImplemented is true, this |
| | Selectors | element ought not be present unless one or more |
| | | BSS membership selectors (see 11.1.4.6 |
| | | (Operation of Supported Rates and BSS |
| | | Membership Selectors element and Extended |
| | | Supported Rates and BSS Membership Selectors |
| | | element) are indicated. |
| 6 | Extended Supported | The Extended Supported Rates and BSS |
| | Rates and BSS | Membership Selectors element is present if the |
| | Membership Selectors | number of supported rates and BSS membership |
| | | selectors together exceed eight; it is optional |
| | | otherwise. |
| | | If dot11S1GOptionImplemented or |
| | | dot11DMGOptionImplemented is true, this |
| | | element ought not be present unless there are more |
| | | than 8 BSS membership selectors (see 11.1.4.6 |
| | | (Operation of Supported Rates and BSS |
| | | Membership Selectors element and Extended |
| | | Supported Rates and BSS Membership Selectors |
| | | element) indicated. |
| 7 | Power Capability | The Power Capability element is present if |
| | | dot11SpectrumManagementRequired is true or |
| | | dot11RadioMeasurementActivated is true. |
| 8 | Supported Channels | The Supported Channels element is present if |
| | | dot11SpectrumManagementRequired is true and |
| | | dot11ExtendedChannelSwitchActivated is false. |
| | | The Supported Channels element is optionally |
| | | present, otherwise. |
| 9 | RSN | The RSNE is present if dot11RSNAActivated is |
| | | true; otherwise not present. |
| 10 | QoS Capability | The QoS Capability element is present if |
| | | dot11QosOptionImplemented is true. |
| 11 | RM Enabled | RM Enabled Capabilities element is present if |
| | Capabilities | dot11RadioMeasurementActivated is true. |
| 12 | Mobility Domain | The MDE is present in a Reassociation Request |
| | | frame if dot11FastBSSTransitionActivated is true |
| | | and the frame is being sent to an AP that |
| | | advertised its FT Capability in the MDE in its |
| | | Beacon or Probe Response frame (i.e., AP also |
| | | has dot11FastBSSTransitionActivated is true). |
| 13 | Fast BSS Transition | An FTE is present in a Reassociation Request |
| | | frame if dot11FastBSSTransitionActivated is true |
| | | and dot11RSNAAuthenticationSuiteSelected is |
| | | equal to an AKM suite selector value for which |
| | | the Authentication type column indicates FT |
| | | authentication. See Table 9-188 (AKM suite selectors) |
| | | (i.e., part of a fast BSS transition in an RSN). |
| 14 | Resource information | The set of elements that formulate a RIC-Request |
| | container (RIC) | is optionally present in a Reassociation Request |
| | | frame if |
| | | dot11FastBSSTransitionActivated is true, |
| | | The FT resource request protocol is not used, |
| | | The frame is being sent to an AP that |
| | | advertised its FT capability in the MDE in its |
| | | Beacon or Probe Response frame (i.e., AP |
| | | also has dot11FastBSSTransitionActivated is |
| | | true), and |
| | | Either dot11RSNAAuthenticationSuiteSelected is |
| | | 00-0F-AC:3, 00-0F-AC:4, 00-0F-AC:9, 00-0F-AC:13, |
| | | 00-0F-AC:16, or 00-0F-AC:17 (i.e., part of a |
| | | fast BSS transition in an RSN) or |
| | | dot11RSNAActivated is false (i.e., not in an RSN). |
| 15 | Supported Operating | The Supported Operating Classes element is present |
| | Classes | if dot11ExtendedChannelSwitchActivated or |
| | | dot11OperatingClassesRequired is true. |
| 16 | HT Capabilities | The HT Capabilities element is present when |
| | | dot11HighThroughputOptionImplemented is true |
| | | and the STA is not a STA 6G.(11ax) |
| 17 | 20/40 BSS | The 20/40 BSS Coexistence element is optionally |
| | Coexistence | present when |
| | | dot112040BSSCoexistenceManagementSupport is true. |
| 18 | Extended | The Extended Capabilities element is present if |
| | Capabilities | any of the fields in this element are nonzero. |
| 19 | QoS Traffic | The QoS Traffic Capability element is present if |
| | Capability | dot11QoSTrafficCapabilityActivated is true. |
| 20 | TIM Broadcast | The TIM Broadcast Request element is present if |
| | Request | dot11TIMBroadcastActivated is true. |
| 21 | FMS Request | The FMS Request element is optionally present if |
| | | dot11FMSActivated is true. |
| 22 | DMS Request | The DMS Request element is optionally present if |
| | | dot11DMSActivated is true. |
| 23 | Interworking | The Interworking element is present if |
| | | dot11InterworkingServiceActivated is true and |
| | | the non-AP STA is requesting unauthenticated |
| | | access to emergency services (see 11.3.5 |
| | | (Association, reassociation, and disassociation)). |
| 24 | Multi-band | The Multi-band element is optionally present if |
| | | dot11MultibandImplemented is true. |
| 25 | DMG Capabilities | The DMG Capabilities element is present if |
| | | dot11DMGOptionImplemented is true. |
| 26 | Multiple MAC | The Multiple MAC Sublayers element is present |
| | Sublayers | if dot11MultipleMACActivated is true. |
| 27 | VHT Capabilities | The VHT Capabilities element is present when |
| | | dot11VHTOptionImplemented is true and the |
| | | STA is not a STA 6G.(11ax) |
| 28 | Operating Mode | The Operating Mode Notification element is |
| | Notification | optionally present if |
| | | dot11OperatingModeNotificationImplemented is true. |
| 29 | FILS Session | The FILS Session element is optionally present if |
| | | dot11FILSActivated is true; otherwise not present. |
| 30 | FILS Public Key | The FILS Public Key element is present if |
| | | dot11FILSActivated is true and FILS Public Key |
| | | authentication is used; otherwise not present. |
| 31 | FILS Key | The FILS Key Confirmation element is present if |
| | Confirmation | dot11FILSActivated is true and FILS |
| | | authentication is used; otherwise not present. |
| 32 | FILS HLP Container | One or more FILS HLP Container elements are |
| | | optionally present if dot11FILSActivated is true; |
| | | otherwise not present. |
| 33 | FILS IP Address | The FILS IP Address Assignment element is |
| | Assignment | optionally present if dot11FILSActivated is true; |
| | | otherwise not present. |
| 34 | TWT | The TWT element is optionally present if |
| | | dot11TWTOptionActivated is true; otherwise not |
| | | present. |
| 35 | AID Request | The AID Request element is present when |
| | | dot11S1GOptionImplemented is true. |
| 36 | S1G Capabilities | The S1G Capabilities element is present if |
| | | dot11S1GOptionImplemented is true; otherwise |
| | | not present. |
| 37 | EL Operation | The EL Operation element is present if |
| | | dot11S1GELOperationActivated is true. |
| 38 | BSS Max | The BSS Max Idle Period element is optionally |
| | Idle Period | present if dot11WirelessManagementImplemented |
| | | and dot11BSSMaxIdlePeriodIndicationByNonAPSTA |
| | | are true, or if dot11S1GOptionImplemented is |
| | | true; otherwise not present. |
| 39 | S1G Relay | The S1G Relay element is optionally present if |
| | | dot11RelaySTAImplemented is true; otherwise |
| | | not present. |
| 40 | Header | The Header Compression element is present if |
| | Compression | dot11PV1MACHeaderOptionImplemented is true. |
| 41 | MAD | The MAD element is optionally present if |
| | | dot11S1GOptionImplemented is true; otherwise |
| | | not present. |
| 42 | Reachable | The Reachable Address element is optionally |
| | Address | present if dot11RelaySTAImplemented is true; |
| | | otherwise not present. |
| 43 | S1G Relay | The S1G Relay Activation element is optionally |
| | Activation | present if dot11RelaySTAImplemented is true; |
| | element | otherwise not present. |
| 44 | CDMG | The CDMG Capabilities element is present if |
| | Capabilities | dot11CDMGOptionImplemented is true; otherwise |
| | | not present. |
| 45 | CMMG | The CMMG Capabilities element is present when |
| | Capabilities | dot11CMMGOptionImplemented is true; |
| | | otherwise not present. |
| 46 | OCI | OCI element is present if dot11FILSActivated |
| | | and dot11RSNAOperatingChannelValidationActivated |
| | | are both true; otherwise not present. |
| 47 | GLK-GCR | The GLK-GCR Parameter Set element is present |
| | Parameter | if dot11GLKImplemented is true to indicate the |
| | Set | number of reorder buffers the STA has to support |
| | | GLK-GCR with GCR block ack and respond to |
| | | corresponding GLK-GCR BlockAckReq frames. |
| | | Otherwise this element is not present. |
| 48 | RSN | The RSNXE is present if any subfield of the |
| | Extension | Extended RSN Capabilities field in this element is |
| | | nonzero, except the Field Length subfield and, in |
| | | the case of FT reassociation, the rules for FT |
| | | reassociation in Table 13-1 (FT authentication |
| | | elements) do not omit the RSNXE from the third |
| | | message. |
| 49 | Supplemental | The Supplemental Class 2 Capabilities element is |
| | Class 2 | present when dot11Class2CapabilitiesOptionImplemented |
| | Capabilities | is true; otherwise not present. |
| 50 | MSCS Descriptor | The MSCS Descriptor element is optionally |
| | | present if dot11MSCSActivated is true; otherwise |
| | | not present. |
| 51 (11ax) | HE Capabilities | The HE Capabilities element is present if |
| | | dot11HEOptionImplemented is true; otherwise, it |
| | | is not present. |
| 52 (11ax) | Channel Switch | The Channel Switch Timing element is optionally |
| | Timing | present if |
| | | dot11HESubchannelSelectiveTransmissionImplemented |
| | | is true; otherwise, it is not present. |
| 53 (11ax) | HE 6 GHz Band | The HE 6 GHz Band Capabilities element is |
| | Capabilities | present if dot11HEOptionImplemented and |
| | | dot11HE6GOptionImplemented are true. |
| 54 (11ax) | UL MU Power | The UL MU Power Capabilities element is |
| | Capabilities | optionally present if dot11HEOptionImplemented |
| | | is true; otherwise, it is not present. |
| 55 (11ay) | EDMG | The EDMG Capabilities element is present if |
| | Capabilities | dot11EDMGOptionImplemented is true. |
| 56 (11ay) | QoS Triggered | The QoS Triggered Unscheduled element is optionally |
| | Unscheduled | present if dot11EDMGOptionImplemented is true. |
| 57 (11ay) | Unsolicited Block | The Unsolicited Block Ack Extension element is |
| | Ack Extension | optionally present if dot11UnsolicitedBAActivated |
| | | is true and is absent otherwise. |
| 58 (11ay) | TDD Slot Schedule | The TDD Slot Schedule element is optionally |
| | | present if dot11DMGOptionImplemented is true. |
| 59 (11ay) | TDD Route | This element is optionally present if |
| | | dot11TDDOptionImplemented is true; otherwise, |
| | | not present. If present, the element specifies the |
| | | TDD beamforming results. |
| 60(11ba) | WUR | The WUR Capabilities element is present when |
| | Capabilities | dot11WUROptionImplemented is true; otherwise |
| | | it is not present. |
| 61(11ba) | WUR Mode | The WUR Mode element is optionally present |
| | | when dot11WUROptionImplemented is true; |
| | | otherwise, it is not present. |
| 62 | Diffie-Hellman | The Diffie-Hellman Parameter element is |
| | Parameter | optionally present when performing OWE; |
| | | otherwise it is not present. |
| Last | Vendor Specific | One or more Vendor Specific elements are |
| | | optionally present. These elements follow all |
| | | other elements. |

TABLE V
Relay Reassociation Response frame body

| Order | Information | Notes |
|---|---|---|
| 1 | Capability | See 9.4.1.4 (Capability Information field) for |
| | Information | Capability Information field format. |
| 2 | Status Code | |
| 3 | AID | This field is not present when |
| | | dot11S1GOptionImplemented is true. |
| 4 | Supported Rates and | If dot11S1GOptionImplemented or |
| | BSS Membership | dot11DMGOptionImplemented is true, this |
| | Selectors | element ought not be present unless one or more |
| | | BSS membership selectors (see 11.1.4.6 |
| | | (Operation of Supported Rates and BSS |
| | | Membership Selectors element and Extended |
| | | Supported Rates and BSS Membership Selectors |
| | | element) are indicated. |
| 5 | Extended Supported | The Extended Supported Rates and BSS |
| | Rates and BSS | Membership Selectors element is present if the |
| | Membership Selectors | number of supported rates and BSS membership |
| | | selectors together exceed eight; it is optional |
| | | otherwise. |
| | | If dot11S1GOptionImplemented or |
| | | dot11DMGOptionImplemented is true, this |
| | | element ought not be present unless there are more |
| | | than 8 BSS membership selectors (see 11.1.4.6 |
| | | (Operation of Supported Rates and BSS |
| | | Membership Selectors element and Extended |
| | | Supported Rates and BSS Membership Selectors |
| | | element) indicated. |
| 6 | EDCA Parameter Set | The EDCA Parameter Set element is present if |
| | | dot11QosOptionImplemented is true; otherwise |
| | | not present. |
| 7 | RCPI | The RCPI element is present if |
| | | dot11RMRCPIMeasurementActivated is true. |
| 8 | RSNI | The RSNI element is present if |
| | | dot11RMRSNIMeasurementActivated is true. |
| 9 | RM Enabled | RM Enabled Capabilities element is present if |
| | Capabilities | dot11RadioMeasurementActivated is true. |
| 10 | RSN | An RSNE is present in a Reassociation Response |
| | | frame if dot11FastBSSTransitionActivated is |
| | | true, dot11RSNAActivated is true, and this frame |
| | | is a response to a Reassociation Request frame |
| | | that contained an FTE (i.e., part of a fast BSS |
| | | transition in an RSN); or if dot11FILSActivated is |
| | | true. Otherwise, not present. |
| 11 | Mobility Domain | An MDE is present in a Reassociation Response |
| | | frame if dot11FastBSSTransitionActivated is true |
| | | and this frame is a response to a Reassociation |
| | | Request frame that contained an MDE (i.e., either |
| | | an FT initial mobility domain association |
| | | exchange or part of a fast BSS transition). |
| 12 | Fast BSS Transition | An FTE is present in a Reassociation Response |
| | | frame if dot11FastBSSTransitionActivated is |
| | | true, dot11RSNAActivated is true, and this frame |
| | | is a response to a Reassociation Request frame |
| | | that contained an MDE (i.e., either an FT initial |
| | | mobility domain association exchange or part of a |
| | | fast BSS transition in an RSN). |
| 13 | RIC | The set of elements that formulate a RIC- |
| | | Response is present in a Reassociation Response |
| | | frame if dot11FastBSSTransitionActivated is true |
| | | and this frame is a response to a Reassociation |
| | | Request frame that contained a RIC-Request. |
| 14 | DSE registered | The DSE Registered Location element is present |
| | location | if dot11LCIDSERequired is true. |
| 15 | Timeout Interval | A TIE containing the association comeback time |
| | (association | is present when dot11RSNAActivated is true, |
| | comeback time) | dot11RSNAProtectedManagementFramesActivated |
| | | is true, and either the reassociation is rejected |
| | | with status code REFUSED_TEMPORARILY or |
| | | the reassociation request is accepted with a status |
| | | code 0 and when dot11S1GOptionImplemented is true. |
| 16 | HT Capabilities | The HT Capabilities element is present when |
| | | dot11HighThroughputOptionImplemented is true |
| | | and the STA is not a STA 6G.(11ax) |
| 17 | HT Operation | The HT Operation element is included by an AP |
| | | when dot11HighThroughputOptionImplemented |
| | | is true and the AP is not a STA 6G.(11ax) |
| 18 | 20/40 BSS | The 20/40 BSS Coexistence element is optionally |
| | Coexistence | present when |
| | | dot112040BSSCoexistenceManagementSupport is true. |
| 19 | Overlapping BSS | The Overlapping BSS Scan Parameters element is |
| | Scan Parameters | optionally present if dot11FortyMHzOptionImplemented |
| | | is true. |
| 20 | Extended Capabilities | The Extended Capabilities element is present if |
| | | any of the fields in this element are nonzero. |
| 21 | BSS Max Idle Period | The BSS Max Idle Period element is present if |
| | | dot11WirelessManagementImplemented is true or |
| | | optionally present if dot11S1GOptionImplemented is true. |
| 22 | TIM Broadcast | The TIM Broadcast Response element is present |
| | Response | if dot11TIMBroadcastActivated is true and the |
| | | TIM Broadcast Request element is present in the |
| | | Reassociation Request frame that elicited this |
| | | Reassociation Response frame. |
| 23 | FMS Response | The FMS Response element is present if |
| | | dot11FMSActivated is true and the FMS Request |
| | | element is present in the Reassociation Request |
| | | frame that elicited this Reassociation Response |
| | | frame. |
| 24 | DMS Response | The DMS Response element is present if |
| | | dot11DMSActivated is true and the DMS Request |
| | | element is present in the Reassociation Request |
| | | frame that elicited this Reassociation Response |
| | | frame. |
| 25 | QoS Map | The QoS Map element is present if |
| | | dot11QosMapActivated is true and the QoS Map |
| | | field in the Extended Capabilities element of the |
| | | corresponding Reassociation Request frame is 1. |
| 26 | QMF Policy | The QMF Policy element is present if |
| | | dot11QMFActivated is true and the |
| | | QMFActivated subfield is 1 in the Extended |
| | | Capabilities element in the Reassociation Request |
| | | that elicited this Reassociation Response frame. |
| 27 | Multi-band | The Multi-band element is optionally present if |
| | | dot11MultibandImplemented is true. |
| 28 | DMG Capabilities | The DMG Capabilities element is present if |
| | | dot11DMGOptionImplemented is true. |
| 29 | DMG Operation | The DMG Operation element is present if |
| | | dot11DMGOptionImplemented is true. |
| 30 | Multiple MAC | The Multiple MAC Sublayers element is present |
| | Sublayers | if dot11MultipleMACActivated is true. |
| 31 | Neighbor Report | One or more Neighbor Report elements is present |
| | | if the Status Code field is REJECTED_{—} |
| | | WITH_SUGGESTED_BSS_TRANSITION. |
| 32 | VHT Capabilities | The VHT Capabilities element is present when |
| | | dot11VHTOptionImplemented is true and the |
| | | STA is not a STA 6G.(11ax) |
| 33 | VHT Operation | The VHT Operation element is present when |
| | | dot11VHTOptionImplemented is true and the |
| | | STA is not a STA 6G and is optionally present if |
| | | dot11HEOptionImplemented is true; otherwise, it |
| | | is not present.(11ax) |
| 34 | Operating Mode | The Operating Mode Notification element is |
| | Notification | optionally present if |
| | | dot11OperatingModeNotificationImplemented is true. |
| 35 | Future Channel | The Future Channel Guidance element is |
| | Guidance | optionally present if |
| | | dot11FutureChannelGuidanceActivated is true. |
| 36 | FILS Session | The FILS Session element is present if |
| | | dot11FILSActivated is true and FILS |
| | | authentication is used; otherwise not present. |
| 37 | FILS Public Key | The FILS Public Key element is present if |
| | | dot11FILSActivated is true and FILS Public Key |
| | | authentication is used; otherwise not present. |
| 38 | FILS Key | The FILS Key Confirmation element is present if |
| | Confirmation | dot11FILSActivated is true and FILS |
| | | authentication is used; otherwise not present. |
| 39 | FILS HLP Container | One or more FILS HLP Container elements are |
| | | optionally present if dot11FILSActivated is true; |
| | | otherwise not present. |
| 40 | FILS IP Address | The FILS IP Address Assignment element is |
| | Assignment | optionally present if dot11FILSActivated is true; |
| | | otherwise not present. |
| 41 | Key Delivery | The Key Delivery element is present if |
| | | dot11FILSActivated is true and FILS |
| | | authentication is used; otherwise not present. |
| 42 | S1G Sector | The S1G Sector Operation element is optionally |
| | Operation | present if dot11S1GSectorizationActivated is |
| | | true; otherwise not present. |
| 43 | TWT | The TWT element is present if |
| | | dot11TWTOptionActivated is true and the TWT element |
| | | is present in the Reassociation Request frame |
| | | that elicited this Reassociation Response frame. |
| | | (11ax)The TWT element is optionally present if |
| | | dot11TWTOptionActivated is true, |
| | | dot11HEOptionImplemented is true, and the |
| | | TWT Requester Support field in the HE |
| | | Capabilities element in the Reassociation Request |
| | | frame that elicited this Reassociation Response |
| | | frame is 1. |
| | | (11ax)Otherwise, the TWT element is not present. |
| | | (11ax)If the TWT element is present in the |
| | | Reassociation Request frame that solicits the |
| | | Reassociation Response frame but the TWT |
| | | element is not present in the Reassociation |
| | | Response frame, then the STA can transmit |
| | | another TWT request frame after association. |
| 44 | TSF Timer Accuracy | The TSF Timer Accuracy element is optionally |
| | | present when dot11TSFTimerAccuracyImplemented |
| | | is true; otherwise not present. |
| 45 | S1G Capabilities | The S1G Capabilities element is present if |
| | | dot11S1GOptionImplemented is true; otherwise |
| | | not present. |
| 46 | S1G Operation | The S1G Operation element is present when |
| | | dot11S1GOptionImplemented is true; otherwise |
| | | not present. |
| 47 | AID Response | The AID Response element is present when |
| | | dot11S1GOptionImplemented is true. |
| 48 | Sectorized Group ID | The Sectorized Group ID List element is |
| | List | optionally present when |
| | | dot11S1GSectorizationActivated is true; |
| | | otherwise not present. |
| 49 | S1G Relay | The S1G Relay element is optionally present if |
| | | dot11RelayAPImplemented is true; otherwise not |
| | | present. |
| 50 | Header Compression | The Header Compression element is present if |
| | | dot11PV1MACHeaderOptionImplemented is true. |
| 51 | SST Operation | The SST Operation element is present if |
| | | dot11SelectiveSubchannelTransmissionPermitted |
| | | is true. |
| 52 | MAD | The MAD element is optionally present if |
| | | dot11S1GOptionImplemented is true; otherwise |
| | | not present. |
| 53 | S1G Relay | The S1G Relay Activation element is optionally |
| | Activation | present if dot11RelaySTAImplemented is true; |
| | | otherwise not present. |
| 54 | CDMG Capabilities | The CDMG Capabilities element is present if |
| | | dot11CDMGOptionImplemented is true; |
| | | otherwise not present. |
| 55 | CMMG Capabilities | The CMMG Capabilities element is present when |
| | | dot11CMMGOptionImplemented is true; |
| | | otherwise not present. |
| 56 | CMMG Operation | The CMMG Operation element is present when |
| | | dot11CMMGOptionImplemented is true; |
| | | otherwise not present. |
| 56 | OCI | The OCI element is present if dot11FILSActivated and |
| | | dot11RSNAOperatingChannelValidationActivated |
| | | are both true; otherwise not present. |
| 58 | GLK-GCR Parameter | The GLK-GCR Parameter Set element is present |
| | Set | if dot11GLKimplemented is true and the AP has |
| | | set up a GLK-GCR for group transmissions over |
| | | the underlying general link. Otherwise this |
| | | element is not present. |
| 59 | RSN Extension | The RSNXE is present if any subfield of the |
| | | Extended RSN Capabilities field in this element is |
| | | nonzero, except the Field Length subfield and, in |
| | | the case of FT reassociation, the rules for FT |
| | | reassociation in Table 13-1 (FT authentication |
| | | elements) do not omit the RSNXE from the fourth |
| | | message. |
| 60 | MSCS Descriptor | The MSCS Descriptor element is optionally |
| | | present if dot11MSCSActivated is true; otherwise |
| | | not present. |
| 61 (11ax) | HE Capabilities | The HE Capabilities element is present if |
| | | dot11HEOptionImplemented is true; otherwise, it |
| | | is not present. |
| 62 (11ax) | HE Operation | The HE Operation element is present if |
| | | dot11HEOptionImplemented is true; otherwise, it |
| | | is not present. |
| 63 (11ax) | BSS Color Change | The BSS Color Change Announcement element is |
| | Announcement | optionally present if dot11HEOptionImplemented |
| | | is true; otherwise, it is not present. |
| 64 (11ax) | Spatial Reuse | The Spatial Reuse Parameter Set element is |
| | Parameter Set | optionally present if dot11HEOptionImplemented |
| | | is true; otherwise, it is not present. |
| 65 (11ax) | MU EDCA Parameter | The MU EDCA Parameter Set element is present |
| | Set | if dot11HEOptionImplemented is true and |
| | | dot11MUEDCAParametersActivated is true; |
| | | otherwise, it is not present. |
| 66 (11ax) | UORA Parameter Set | The UORA Parameter Set element is optionally |
| | | present if dot11HEOptionImplemented is true; |
| | | otherwise, it is not present. |
| 67 (11ax) | ESS Report | The ESS Report element is optionally present. |
| 68 (11ax) | NDP Feedback Report | The NDP Feedback Report Parameter Set element |
| | Parameter Set | is optionally present if dot11HEOptionImplemented |
| | | is true; otherwise, it is not present. |
| 69 (11ax) | HE 6 GHz Band | The HE 6 GHz Band Capabilities element is |
| | Capabilities | present if dot11HEOptionImplemented and |
| | | dot11HE6GOptionImplemented are true. |
| 70 (11ay) | EDMG Capabilities | The EDMG Capabilities element is present if |
| | | dot11EDMGOptionImplemented is true. |
| 71 (11ay) | EDMG Operation | The EDMG Operation element is present if |
| | | dot11EDMGOptionImplemented is true. |
| 72 (11ay) | QoS Triggered | The QoS Triggered Unscheduled element is |
| | Unscheduled | optionally present if dot11EDMGOptionImplemented |
| | | is true. |
| 73 (11ay) | Unsolicited Block | The Unsolicited Block Ack Extension element is |
| | Ack Extension | optionally present if dot11UnsolicitedBAActivated |
| | | is true and is absent otherwise. |
| 74 (11ay) | TDD Slot Structure | The TDD Slot Structure element is optionally |
| | | present if dot11DMGOptionImplemented is true. |
| 75 (11ay) | TDD Slot Schedule | The TDD Slot Schedule element is optionally |
| | | present if dot11DMGOptionImplemented is true. |
| 76 (11ay) | TDD Route | This element is optionally present if |
| | | dot11TDDOptionImplemented is true; otherwise, |
| | | not present. If present, the element specifies the |
| | | TDD sector switch configuration. |
| 77(11ba) | WUR Capabilities | The WUR Capabilities element is present when |
| | | dot11WUROptionImplemented is true; otherwise |
| | | it is not present. |
| 78(11ba) | WUR Operation | The WUR Operation element is present when |
| | | dot11WUROptionImplemented is true; otherwise |
| | | it is not present. |
| 79(11ba) | WUR Mode | The WUR Mode element is present when |
| | | dot11WUROptionImplemented is true, and the |
| | | WUR Mode element is present in the Reassociation |
| | | Request frame that solicited this Reassociation |
| | | Response frame; otherwise it is not present. |
| 80 | Diffie-Hellman | The Diffie-Hellman Parameter element is |
| | Parameter | optionally present when performing OWE; |
| | | otherwise it is not present. |
| Last | Vendor Specific | One or more Vendor Specific elements are |
| | | optionally present. These elements follow all |
| | | other elements. |

In some embodiments, the Relay (Re) Association Request/Response frames may also include the below information, which can include certain standard fields and certain additional fields, including a Relay Capabilities field and a Relay Traffic Indication field as described below.

| Order | | |
|---|---|---|
| . . . | Information | Notes |
| 12 | Quiet | The Quiet element is optionally present if |
| | | dot11SpectrumManagementRequired is true or |
| | | dot11RadioMeasurementActivated is true or |
| | | dot11RestrictedTWTOptionImplemented is true. |
| . . . | | |
| 79 | TWT | The TWT element is optionally present if |
| | | dot11TWTOptionActivated is true. The TWT |
| | | element is present if the |
| | | dot11RestrictedTWTOptionImplemented is true |
| | | and the AP has at least one R- TWT schedule as |
| | | described in 35.8.3 (R-TWT announcement; |
| | | otherwise, it is not present. |
| . . . | | |
| <Last | Multi- | If dot11MultiLinkActivated is true, the Basic |
| assigned + | Link | Multi-Link element is present and the |
| 1> | | Reconfiguration Multi-Link element is optionally |
| | | present; otherwise Multi-Link element is not present. |
| <Last | EHT | The EHT Capabilities element is present if |
| assigned + | Capabilities | dot11EHTOptionImplemented is true; otherwise |
| 2> | | it is not present. |
| <Last | EHT Operation | The EHT Operation element is present if |
| assigned + | | dot11EHTOptionImplemented is true; otherwise |
| 3> | | it is not present. |
| <Last | Multi-Link | The Multi-Link Traffic Indication element is |
| assigned + | Traffic | present if dot11MultiLinkTrafficIndicationActivated |
| 4> | Indication | is true; other- wise it is not present. |
| <Last | TID-To-Link | One or two TID-To-Link Mapping elements are |
| assigned + | Mapping | optionally present if dot11MultiLinkActivated |
| 5> | | and dot11TIDtoLinkMappingActivated are true; |
| | | otherwise, none are present. |
| <Last | Relay | The Relay Capabilities element contains a set of |
| assigned + | Capabilities | information pertaining to the capabilities of the |
| 6> | | relay node. |
| <Last | Relay Traffic | The Relay Traffic Indication element contains a |
| assigned + | Indication | set of information that indicates whether the |
| 7> | | source node has information pending that needs |
| | | to be delivered to the relay node. |

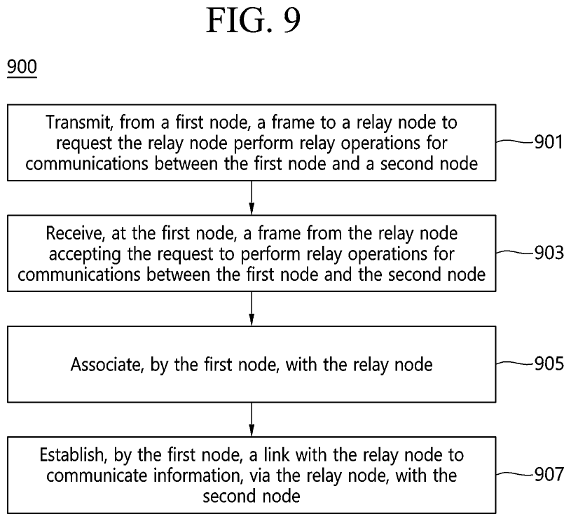

FIG. 9 illustrates an example flowchart of a process for associating by a first node with a relay node in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed by a node, such as the source node or the destination node illustrated in FIG. 6, 7, or 8.

The process 900, in operation 901, the first node transmits a frame to a relay node to request the relay node perform relay operations for communications between the first node and a second node. In certain embodiments, the relay node may provide AP functionalities. In several embodiments, the first node is a source node. In certain embodiments, the first node is a destination node. The first node may be a non-AP STA and the second node is an AP. In certain embodiments, the first node may be an AP and the second node may be a non-AP STA.

In operation 903, the first node receives a frame from the relay node accepting the request to perform relay operations for communications between the first node and the second node. In certain embodiments, the frame may include information pertaining to the relay, including information on the availability of the relay node indicating the time period when the relay node will be available for the relaying operation.

In operation 905, the first node associates with the relay node.

In operation 907, the first node establishes a link with the relay node to communicate, via the relay node, with the second node. In certain embodiments, the first node may then transmit a frame to the second node, via the relay node.

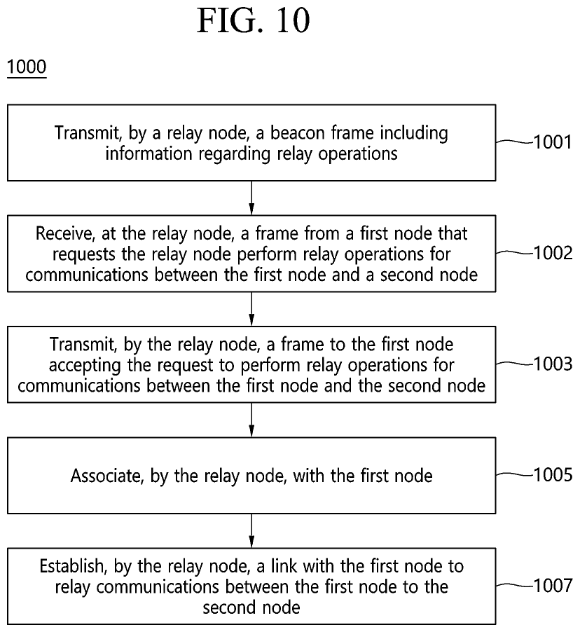

FIG. 10 illustrates an example flowchart of a process for associating by a relay node with a first node in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed by a relay node, such as the relay node illustrated in FIG. 6, 7, or 8.

The process 1000, in operation 1001, the relay node transmits a beacon frame that includes information regarding relay operations. In several embodiments, the relay node can periodically transmit beacon frames. The beacon frame may include information on the availability of the relay node including the time period when the relay node will be available for the relaying operations. In certain embodiments, the frame may be a broadcast or multicast frame that can be transmitted for discovery operations. In some embodiments, the relay beacon frame may include information regarding capabilities of the relay node. In certain embodiments, the relay beacon frame may include information regarding whether a source node has information pending that needs to be delivered to the relay node.

In operation 1002, the relay node receives a frame from a first node that requests the relay node perform relay operations for communications between the first node and a second node. In several embodiments, the relay node may provide AP functionalities. In several embodiments, the first node is a source node. In certain embodiments, the first node is a destination node. The first node may be a non-AP STA and the second node is an AP. In certain embodiments, the first node may be an AP and the second node may be a non-AP STA.

In operation 1003, the relay node transmits a frame to the first node accepting the request to perform relay operations for communications between the first node and the second node. In certain embodiments, the frame may include information pertaining to the relay, including information on the availability of the relay node indicating the time period when the relay node will be available for the relaying operation.

In operation 1005, the relay node associates with the first node. In certain embodiments, the relay node may associate with both the first node and the second node.

In operation 1007, the relay node establishes a link with the first node to relay communications between the first node and the second node, via the relay node. In certain embodiments, the relay node may then receive a frame from the first node and relays the frame to the second node. The relay node may receive a frame from the second node and relay the frame to the first node.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory;
a processor coupled to the memory, the processor configured to:
transmit a first frame to a relay node that requests the relay node to perform a relay operation for a communication between the first STA and a second STA;
receive a second frame from the relay node accepting the request to perform the relay operation for the communication between the first STA and the second STA;
associate with the relay node based on the acceptance of the relay node to perform the relay operation;
establish a relay link between the first STA and the relay node based on the association with the relay node; and
communicate indirectly with the second STA via the relay link.

2. The first STA of claim 1, wherein the relay node is associated with the first STA and the second STA.

3. The first STA of claim 1, wherein the relay node has access point (AP) functionalities.

4. The first STA of claim 1, wherein the processor is further configured to receive a third frame from the relay node that includes information on an availability of the relay node including a time period during which the relay node is available to perform the relay operation.

5. The first STA of claim 1, wherein the processor is further configured to receive a third frame from the relay node that includes information regarding capabilities of the relay node to perform the relay operation.

6. The first STA of claim 1, wherein the processor is further configured to transmit a third frame to the relay node to temporarily disable the relay link with the relay node.

7. The first STA of claim 6, wherein the processor is further configured to transmit a fourth frame to the relay node to reassociate with the relay node and re-enable the relay link.

8. The first STA of claim 1, wherein the processor is further configured to:
transmit a third frame to the relay node that requests information regarding capabilities of the relay node to perform relay operations; and
receive a fourth frame from the relay node that includes relay information including capabilities of the relay node to perform relay operations.

9. A relay station (STA) in a wireless network, the relay STA comprising:
a memory;
a processor coupled to the memory, the processor configured to:
receive a first frame from a first STA that requests the relay STA to perform a relay operation for a communication between the first STA and a second STA;
transmit a second frame to the first STA accepting the request to perform the relay operation for the communication between the first STA and the second STA;
associate with the first STA based on the acceptance with the first STA to perform the relay operation;
establish a relay link between the relay STA and the first STA based on the association with the first STA; and
transmit communications indirectly between the first STA and the second STA via the relay link with the first STA.

10. The relay STA of claim 9, wherein the relay STA is associated with the first STA and the second STA.

11. The relay STA of claim 9, wherein the relay STA has access point (AP) functionalities.

12. The relay STA of claim 9, wherein the processor is further configured to transmit a third frame to the first STA that includes information on an availability of the relay STA including a time period during which the relay STA is available to perform the relay operation.

13. The relay STA of claim 9, wherein the processor is further configured to transmit a third frame to the first STA that includes information regarding capabilities of the STA node to perform the relay operation.

14. The relay STA of claim 9, wherein the processor is further configured to receive a third frame from the first STA to temporarily disable the relay link with the first STA.

15. The relay STA of claim 14, wherein the processor is further configured to receive a fourth frame to the first STA to reassociate with the first STA and re-enable the relay link.

16. The relay STA of claim 9, wherein the processor is further configured to:
receive a third frame from the first STA that requests information regarding capabilities of the relay STA to perform the relay operation; and
transmit a fourth frame to the first STA that includes relay information including capabilities of the relay STA to perform relay operations.

17. A computer-implemented method for facilitating communication at a first station (STA) in a wireless network, the method comprising:
transmitting a first frame to a relay node that requests the relay node to perform a relay operation for a communication between the first STA and a second STA;
receiving a second frame from the relay node accepting the request to perform the relay operation for the communication between the first STA and the second STA;
associating with the relay node based on the acceptance of the relay node to perform the relay operation;
establishing a relay link between the first STA and the relay node based on the association with the relay node; and
communicating indirectly with the second STA via the relay link.

18. The computer-implemented method of claim 17, wherein the relay node is associated with the first STA and the second STA.

19. The computer-implemented method of claim 17, wherein the relay node has access point (AP) functionalities.

20. The computer-implemented method of claim 17, further comprising receiving a third frame from the relay node that includes information on an availability of the relay node including a time period during which the relay node is available to perform the relay operation.
